(19) United States
(12) Patent Application Publication
(10) Pub. No.: US 2018/0282207 A1
(43) Pub. Date: Oct. 4, 2018

(54) MANUFACTURING METHOD OF PROCESSED MEMBER, PLATE MEMBER, AND OPENING MEMBER

(71) Applicant: ASAHI GLASS COMPANY, LIMITED, Chiyoda-ku (JP)

(72) Inventors: Makoto FUJII, Tokyo (JP); Takeshi Hirose, Tokyo (JP)

(73) Assignee: ASAHI GLASS COMPANY, LIMITED, Chiyoda-ku (JP)

(21) Appl. No.: 15/945,185

(22) Filed: Apr. 4, 2018

(30) Foreign Application Priority Data
Apr. 4, 2017 (JP) 2017-074753

(51) Int. Cl. C03C 19/00; C03B 23/035; C03B 25/02; C03C 21/00; C03C 3/083; C03C 3/085; C03C 3/087; C03C 4/18

(52) U.S. Cl. CPC C03C 19/00; C03B 23/0357; C03B 25/025; C03C 21/002; C03C 17/23; C03C 3/085; C03C 3/087; C03C 4/18; C03C 3/083

(57) ABSTRACT

The present invention relates to a manufacturing method of a processed member including removing a first uplift portion from a plate member containing the first uplift portion and a support portion connecting to the first uplift portion, in which the plate member includes a first main surface and a second main surface, the first uplift portion is a projection portion in the first main surface and a portion in the second main surface, corresponding to the projection portion is a recess portion, and the first uplift portion has a line shape in a top view.

### TECHNICAL FIELD

The present invention relates to a manufacturing method of a processed member, a plate member, and an opening member.

### BACKGROUND ART

Generally, from the viewpoint of functionality and aesthetics, glass or small pieces of glass in which an opening portion or the like is at least provided partially are required.

Patent Document 1 discloses a method in which a portion of bent glass is mechanically cut by using a drill provided with a grinding stone, so as to create an opening portion in the glass.

Patent Document 2 discloses a method in which a masking layer having chemical resistance is formed at portions of glass other than a portion at which a through-hole is desired to be formed and the portion of the glass on which the masking layer is not formed is dissolved by chemical treatment, thereby creating an opening portion, or a method of obtaining a large number of small pieces of glass.
Patent Document 1: WO 2016/136758
Patent Document 2: JP-A-2013-1599

### SUMMARY OF THE INVENTION

According to Patent Document 1, the opening portion is created in a manner that the drill provided with a grinding stone is brought into contact on the glass to mechanically cut the glass by the thickness of the glass. In the case where an area at which the opening portion is desired to be formed is large, the entirety of a contact surface of the grinding stone is brought into contact on the glass and then cutting is performed. In this case, a contact area between the grinding stone and the glass is large and thus a frictional force is also increased. Accordingly, vibrations of the drill provided with the grinding stone spread widely in the glass, and thus the glass is broken in many cases. In particular, in the case of thin glass, strength is weak and breaking occurs more easily. Thus, it is difficult to form the opening portion.

According to Patent Document 2, first, the masking layer is formed to cover portions other than a desired portion at which the opening portion is desired to be formed. The opening portion is made with an aqueous etching solution containing hydrofluoric acid. At this time, the shape of an opening is easily influenced by contact conditions of the aqueous etching solution, and thus it is not possible to form an opening in the glass with high precision. Furthermore, since a step of forming the masking layer is provided, steps are complicated.

Considering the above-described problems, an object of the present invention is to provide a manufacturing method of a processed member, in which an opening member or a small plate piece can be manufactured with high efficiency and high precision, a plate member used therein, and an opening member which is finally obtained.

The above object of the present invention has been achieved by the configuration as follows.

[1] A manufacturing method of a processed member including:

removing a first uplift portion from a plate member containing the first uplift portion and a support portion connecting to the first uplift portion, in which

the plate member includes a first main surface and a second main surface,

the first uplift portion is a projection portion in the first main surface and a portion in the second main surface, corresponding to the projection portion is a recess portion, and

the first uplift portion has a line shape in a top view.

[2] The manufacturing method according to [1], in which the first uplift portion is removed by grinding with a grinding stone.
[3] The manufacturing method according to [1] or [2], in which the first uplift portion is removed by polishing with abrasive grains.
[4] The manufacturing method according to any one of [1] to [3], in which the first uplift portion is removed in a state where the second main surface of the plate member is fixed by a fixing member.
[5] The manufacturing method according to any one of [1] to [4], in which the first uplift portion is endless in a top view.
[6] The manufacturing method according to any one of [1] to [5], in which the first uplift portion includes a base portion and a protrusion portion.
[7] The manufacturing method according to any one of [1] to [6], in which the first uplift portion is formed by a vacuum shaping method.
[8] The manufacturing method according to any one of [1] to [6], in which the first uplift portion is formed by a press shaping method.
[9] The manufacturing method according to any one of [1] to [8], in which the first uplift portion has a thickness of 5 mm or smaller.
[10] The manufacturing method according to any one of [1] to [9], in which the first uplift portion has a thickness thinner than a thickness of the support portion.
[11] The manufacturing method according to any one of [1] to [10], in which the first uplift portion has a thickness 90% or smaller with respect to a thickness of the support portion.
[12] The manufacturing method according to any one of [1] to [11], in which the processed member includes two or more first uplift portions.
[13] The manufacturing method according to [12], in which a minimum distance between the two or more first uplift portions is 10 mm or smaller.
[14] The manufacturing method according to any one of [1] to [13], in which the plate member is made of glass.
[15] A plate member including: a first uplift portion, a support portion connecting to the first uplift portion, and an alignment mark, in which

the plate member includes a first main surface and a second main surface,

the first uplift portion is a projection portion in the first main surface and a portion in the second main surface, corresponding to the projection portion is a recess portion, and

the first uplift portion has a line shape in a top view.

[16] The plate member according to [15], in which the first uplift portion includes a base portion and a protrusion portion.
[17] The plate member according to [15] or [16], in which the first uplift portion has a thickness of 5 mm or smaller.
[18] The plate member according to any one of [15] to [17], in which the first uplift portion has a thickness thinner than a thickness of the support portion.
[19] The plate member according to any one of [15] to [18], in which the first uplift portion has a thickness 90% or smaller of a thickness of the support portion.
[20] The plate member according to any one of [15] to [19], including two or more first uplift portions.
[21] The plate member according to [20], in which a minimum distance between the two or more first uplift portions is 10 mm or smaller.
[22] The plate member according to any one of [15] to [21], in which the first uplift portion is endless in a top view.
[23] The plate member according to any one of [15] to [22], made of glass.
[24] An opening member including a plate having a first main surface and a second main surface, in which

the plate includes an opening portion and a structural portion forming and supporting the opening portion, and

a top-view projected shape formed by an end surface of the opening portion, on the first main surface side, is different from the top-view projected shape on the second main surface.

[25] The opening member according to [24], in which a top-view end surface shape formed by an end surface of the opening portion on the first main surface side has a relation of being included in a top-view end surface shape formed by an end surface of the opening portion on the second main surface side.
[26] The opening member according to [24] or [25], in which the plate further contains a base portion protruding toward the plate on the first main surface side of the plate, and the opening portion is provided on the base portion.
[27] The opening member according to any one of [24] to [26], in which the structural portion has a thickness of 5 mm or smaller.
[28] The opening member according to [27], in which the plate includes two or more opening portions and a minimum distance between the two or more opening portions is 10 mm or smaller.
[29] The opening member according to any one of [24] to [28], in which the plate is made of glass.
[30] The opening member according to [29], in which at least one of the two main surfaces of the plate includes a compressive stress layer.

According to the present invention, a manufacturing method of a processed member, in which an opening member or a small plate piece can be manufactured with high efficiency and high precision, a plate member used therein, and an opening member which is finally obtained can be provided.

### BRIEF DESCRIPTION OF THE DRAWINGS

FIG. 1 illustrates an example of a plate member according to an embodiment of the present invention; (a) of FIG. 1 is a plan view when viewed from a first main surface; (b) of FIG. 1 is a sectional view of I-I portion; and (c) of FIG. 1 illustrates an example in which a curve portion includes a flat portion.

FIG. 2 includes plan views of plate members ((a) and (b)) each according to another embodiment of the present invention when viewed from a first main surface.

FIG. 3 illustrates an example of an opening member according to an embodiment of the prevent invention; (a) of FIG. 3 is a plan view when viewed from a first main surface; (b) of FIG. 3 is a sectional view of III-III portion; and (c) of FIG. 3 is a partial enlarged view of the opening portion.

FIG. 4 illustrates an example of a small plate piece according to the embodiment of the present invention; (a) of FIG. 4 is a plan view when viewed from a first main surface; (b) of FIG. 4 is a sectional view of IV-IV portion; and (c) of FIG. 4 is a top-view projection view of the small plate piece.

FIG. 5 includes a schematic diagram illustrating a step of preparing a shaping die ((a) of FIG. 5) and a schematic diagram illustrating a step of pre-heating the shaping die ((b) of FIG. 5).

FIG. 6 includes a schematic diagram illustrating a step of placing a plate on the pre-heated shaping die and fixing the plate with a binding jig ((a) of FIG. 6) and a schematic diagram illustrating a step of obtaining a plate member by increasing the temperature of the plate up to a forming temperature so as to shape a plate ((b) of FIG. 6).

FIG. 7 includes a schematic diagram illustrating a step of cooling the plate member ((a) of FIG. 7) and a schematic diagram illustrating a step of separating the plate member from the shaping die ((b) of FIG. 7).

FIG. 8 includes schematic diagrams in a thickness-direction sectional view of a plate member in an embodiment of the present invention, illustrating a step of obtaining a sectional-view shape as in (b) or (c) by removing a first uplift portion as in (a).

FIG. 9 includes schematic diagrams ((a) and (b)) illustrating a step of removing a first uplift portion of a plate member by using a tool.

FIG. 10 includes schematic diagrams in a thickness-direction sectional view of a plate member in still another embodiment of the present invention, illustrating a step of obtaining a sectional-view shape as (b) or (c) by removing a first uplift portion as in (a).

FIG. 11 includes schematic diagrams in a thickness-direction sectional view of a plate member in still another embodiment of the present invention, illustrating a step of obtaining a sectional-view shape as in (b) by removing a first uplift portion as in (a).

FIG. 12 includes schematic diagrams ((a) to (d)) illustrating a method of manufacturing an opening member from a plate member in Example 1.

FIG. 13 includes schematic diagrams ((a) to (d)) illustrating a method of manufacturing an opening member from a plate member in Example 2.

FIG. 14 includes schematic diagrams ((a) to (d)) illustrating a method of manufacturing an opening member from a plate member in Example 3.

FIG. 15 includes partial sectional views; (a) of FIG. 15 is a partial sectional view of XVa-XVa portion of (a) of FIG. 14; (b) of FIG. 15 is a partial sectional view of XVb-XVb portion of (b) of FIG. 14; and (c) of FIG. 15 is a partial sectional view of XVc-XVc portion of (c) of FIG. 14.

FIG. 16 includes illustrating views of Example 4; (a) of FIG. 16 is a top view of a plate member; (b) of FIG. 16 is a top view of an obtained opening member; and (c) of FIG. 16 is a schematic diagram illustrating a usage example of the obtained opening member.

FIG. 17 includes illustrating views of Example 5; (a) of FIG. 17 is a top view of a plate member; and (b) of FIG. 17 is a top view of an obtained opening member.

### MODE FOR CARRYING OUT THE INVENTION

Hereinafter, a manufacturing method of a processed member, a plate member and an opening member according to embodiments of the present invention will be described in detail with reference to the drawings.

### Plate Member 3

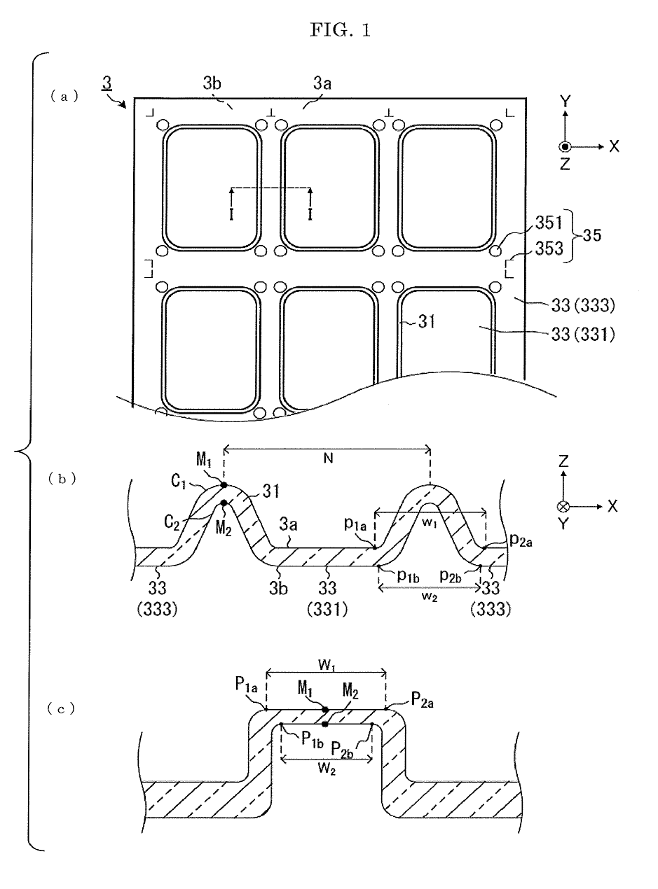

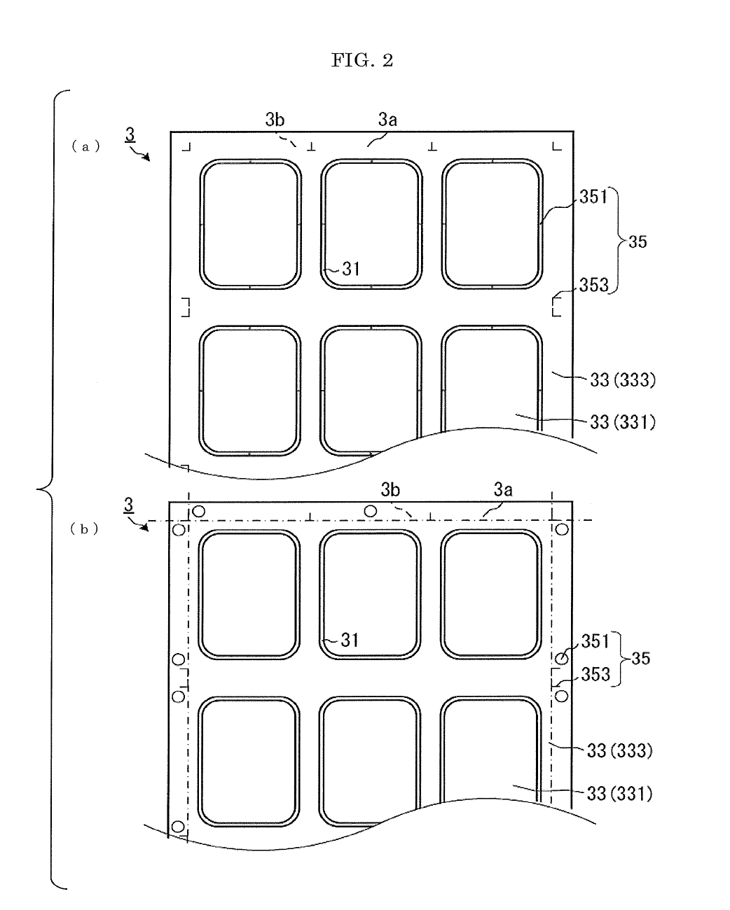

A plate member 3 according to an embodiment of the present invention is as illustrated in FIG. 1 and FIG. 2. The plate member 3 is manufactured from a plate 1 having a first main surface and a second main surface. The plate member 3 in this embodiment has a substantially rectangular shape. The plate member 3 includes one or more first uplift portions 31 which are aligned and arranged in XY-directions, a support portion 33 which is connected to a circumferential portion of the first uplift portion 31, and an alignment mark 35 which can be used for positioning or as a cutting line. Descriptions will be made on the embodiment where the plate member 3 has a substantially rectangular shape in a plan view. However, the shape of the plate member 3 is not particularly limited and may be circular or polygonal.

In this embodiment, a direction in which one side of the plate member 3 extends is set as an X-direction. A direction in which another side which is adjacent and orthogonal to the one side extends is set as a Y-direction. A direction orthogonal to the X-direction and the Y-direction (direction from a second main surface 3b toward a first main surface 3a) is set as a Z-direction.

### Plate 1

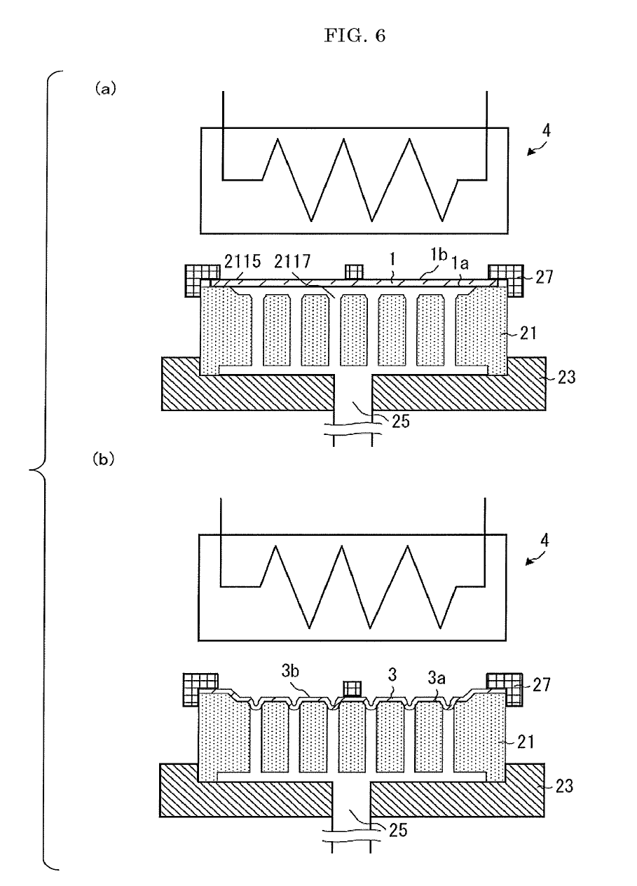

The plate 1 has a first main surface 1a and a second main surface 1b (see (a) of FIG. 6). The first main surface 1a and the second main surface 1b are parallel to each other in the plate 1 having the above configuration, but are not necessarily parallel to each other. The plate 1 is not limited to a flat plate and may be a curved plate including a curved portion different from the first uplift portion 31. The “curved portion” means a portion having an average curvature radius which is not infinite, specifically, a portion having an average curvature radius of 5,000 mm or smaller. The plate 1 may have a shape in which the entire surface thereof is bent.

Examples of the plate 1 include plates made of glass, ceramics, resin, wood, metal, and the like. Among them, glass is preferable. As the glass, crystallized glass, colored glass and the like can be exemplified in addition to colorless and transparent amorphous glass. In the manufacturing method of a processed member 5 according to the present invention, which will be described later, an opening member 53 in which an opening portion is efficiently formed can be obtained even from a brittle material such as thin glass having low strength, and a large amount of small plate pieces 51 can be also obtained at once.

In the case where the plate 1 is made of glass, the thickness T is preferably 0.2 mm or greater. If glass having a thickness being the lower limit value or greater is used, even in the manufacturing method of the processed member 5 in the embodiment, which will be described later, the opening member 53 in which an opening portion is efficiently formed and a large amount of small plate pieces can be obtained at once. The thickness T of the glass is more preferably 0.4 mm or greater, further preferably 0.5 mm or greater, and particularly preferably 0.7 mm or greater.

The upper limit value of the thickness T is preferably 5 mm or smaller. In the case of the thickness T being greater than the upper limit value, a load applied in a step of forming the first uplift portion 31 is increased, and a load applied in a step of removing the first uplift portion 31 in the manufacturing method of the processed member 5 according to the present invention, which will be described later, is also increased. If the thickness T of the plate 1 is the upper limit value or smaller, there are advantages in that reduction in weight can be achieved and the plate member 3 and the processed member 5 which have high strength and favorable texture can be obtained. The thickness T of the glass is more preferably 4 mm or smaller, further preferably 3 mm or smaller, and particularly preferably 2 mm or smaller.

The plate 1 is not limited to flat and smooth plate. Use can be made of a substrate on which an antiglare treatment layer has been formed by etching or coating in advance. Furthermore, not limited to the antiglare treatment layer, the plate 1 may have a mold-releasing layer which makes the plate 1 be easily released from a shaping die in the forming step, which will be described later, or may have an antireflection treatment layer.

### First Uplift Portion 31

In a thickness-direction sectional view of the plate member 3, the first uplift portion 31 is formed to be a projection portion in the first main surface 3a, and to cause a portion corresponding to the projection portion, in the second main surface 3b, to be a recess portion. The first uplift portion 31 can be simply removed by the manufacturing method of the processed member 5 according to the present invention, which will be described later, and thus the opening member 53 having an opening portion can be efficiently manufactured from the plate member 3. A large amount of small plate pieces 51 can be obtained from the plate member 3 at once. The first uplift portion 31 is preferably formed by heating and shaping the plate 1.

In the first uplift portion 31, curves C₁ and C₂ (generalized and also described as “curve C” below) formed by the first main surface 3a and the second main surface 3b, respectively, preferably have an extreme value in the thickness-direction sectional view of the plate member 3. (b) of FIG. 1 is a partial sectional view illustrating I-I portion of the plate member 3 in (a) of FIG. 1. In (b) of FIG. 1, the curves C₁ and C₂ are parabolic curves which are convex in a Z-axis positive direction. The curves C₁ and C₂ have vertexes M₁ and M₂, respectively, each having a maximum value (generalized and also described as “vertex M” below). In the curves C₁ and C₂, although the number of extreme values is not particularly limited, 1 to 5 per one first uplift portion 31 are preferable. This is because the removal amount of the first uplift portion 31 can be reduced and the processed member 5 can be efficiently manufactured, in the manufacturing method of the processed member 5 in the present invention, which will be described later. The number of extreme values is preferably 1 to 3 and further preferably 1.

The curvature radius at the vertex M₁ is preferably 0.05 mm or greater. This is because, in the case where the first uplift portion 31 is formed by heating and shaping as described later, the plate member 3 can be efficiently obtained while efficiently preventing the glass as the plate 1 or a mold to be used from breaking. The curvature radius at the vertex M₁ is more preferably 0.1 mm or greater and further preferably 0.5 mm or greater.

The curvature radius at the vertex M₁ is preferably 5 mm or smaller. This is because the removal amount of the first uplift portion 31 can be reduced and the processed member 5 can be efficiently obtained, in the manufacturing method of the processed member 5 in the present invention, which will be described later. The curvature radius at the vertex M₁ is preferably 3 mm or smaller and further preferably 1 mm or smaller.

The curvature radius at the vertex M₂ is preferably 0.05 mm or greater. This is because, in the case where the first uplift portion 31 is formed by heating and shaping as described later, the plate member 3 can be efficiently obtained while efficiently preventing the glass as the plate 1 or a mold to be used from breaking. The curvature radius at the vertex M₂ is more preferably 0.1 mm or greater and further preferably 0.5 mm or greater.

The curvature radius at the vertex M₂ is preferably 5 mm or smaller. This is because the removal amount of the first uplift portion 31 can be reduced and the processed member 5 can be efficiently obtained, in the manufacturing method of the processed member 5 in the present invention, which will be described later. The curvature radius at the vertex M₂ is preferably 3 mm or smaller and further preferably 1 mm or smaller.

In the case where the curve C has a flat portion at the highest point, as illustrated in (c) of FIG. 1, the midpoint of the flat portion may be set as the vertex M. In this case, the lower limit value of a width W₁ of the flat portion on the first main surface 3a side is not particularly limited. The width W₁ is preferably 10 mm or smaller. This is because the removal amount of the first uplift portion 31 can be reduced and the processed member 5 can be efficiently obtained, in the manufacturing method of the processed member 5 in the present invention, which will be described later. The width W₁ is more preferably 8 mm or smaller and further preferably 5 mm or smaller.

The lower limit value of a width W₂ of the flat portion on the second main surface 3b side is not particularly limited. The width W₂ is preferably 10 mm or smaller. This is because the removal amount of the first uplift portion 31 can be reduced and the processed member 5 can be efficiently obtained, in the manufacturing method of the processed member 5 in the present invention, which will be described later. The width W₂ is more preferably 8 mm or smaller and further preferably 5 mm or smaller.

Each of the widths W₁ and W₂ of the flat portion is set as a length of a line connecting two points, that is, boundary points at which the height starts to change in the Z-direction in the curve C including the flat portion, in the corresponding main surface in the thickness-direction sectional view of the plate member 3. In (c) of FIG. 1, the width W₁ means a distance between a point P₁ₐ and a point P₂ₐ, the width W₂ means a distance between a point P_{1b} and a point P_{2b}.

If the height Z of the second main surface 3b constituting the support portion 33 of the plate member 3 is set to 0 and the direction from the second main surface 3b to the first main surface 3a is set to be a positive direction of the Z direction, the height of the vertex M₂ is preferably higher than the first main surface 3a of the support portion 33. In this case, if the first uplift portion 31 is removed, the opening portion 531 can be easily obtained, in the manufacturing method of the processed member 5 in the present invention, which will be described later. Furthermore, smooth end surface can be obtained without processing the end surface 535 of the opening portion, and thus an occurrence of cracks as a start point of breaking can be suppressed.

The height of the vertex M₂ from the second main surface 3b of the support portion 33 is preferably 4 times or smaller the thickness T of the plate 1. This is because, if the first uplift portion 31 is removed, the opening portion 531 can be easily obtained, in the manufacturing method of the processed member 5 in the present invention, which will be described later. The height of the vertex M₂ is more preferably 3 times or smaller the thickness T of the plate 1 and further preferably 2 times or smaller.

The height of the vertex M₂ from the second main surface 3b of the support portion 33 is preferably 1.02 times or greater the thickness T of the plate 1. This is because, if the first uplift portion 31 is removed, the opening portion 531 can be reliably obtained regardless of shaping accuracy of the first uplift portion 31 and removal precision of the first uplift portion 31, in the manufacturing method of the processed member 5 in the present invention, which will be described later. The height of the vertex M₂ is more preferably 1.05 times or greater the thickness T of the plate 1 and further preferably 1.1 times or greater.

Instead of the thickness T of the plate 1, the thickness t of the support portion 33 may be used.

The first uplift portion 31 has a line shape in a top view when viewed from the first main surface 3a side. Since the first uplift portion 31 has a line shape, the first uplift portion 31 can be simply removed by the manufacturing method of the processed member 5 in the present invention, which will be described later, and a working load can be reduced. In the case where the thickness of the plate member 3 is thin, a contact area between a tool used when the first uplift portion 31 is ground or polished, and the plate member 3 can be reduced. Thus, the processed member 5 can be also efficiently manufactured from a brittle material having weak strength. Incidentally, the sectional-view shape and width of the first uplift portion 31 in the present specification mean, unless otherwise specified, the shape and width, respectively, perpendicular to the direction in which the first uplift portion 31 extends in a line shape.

The first uplift portion 31 is preferably endless in a top view when viewed from the first main surface 3a side. In the case where the first uplift portion 31 is endless, a portion surrounded by the first uplift portions 31 can also be removed and the opening member 53 can be efficiently manufactured, when the first uplift portion 31 is removed by the manufacturing method of the processed member 5 in the present invention, which will be described later. In addition, in the case where the shape of the first uplift portion 31 is set to be endless with a desired shape, an opening portion 531 having the desired shape can be obtained and high processability can be secured.

The thickness t′ of the first uplift portion 31 is preferably 0.2 mm or greater. If the thickness t′ of the first uplift portion 31 is smaller than the lower limit value, in the case where a brittle material as glass is used, a start point of cracks can easily occur and the plate member 3 is easily broken. The thickness t′ of the first uplift portion 31 is more preferably 0.4 mm or greater, further preferably 0.5 mm or greater, and particularly preferably 0.7 mm or greater.

The upper limit value of the thickness t′ of the first uplift portion 31 is preferably 5 mm or smaller. In the case of the thickness t′ being greater than the upper limit value, a load when the first uplift portion 31 is removed in the manufacturing method of the processed member 5 which will be described later is high. If the first uplift portion 31 is the upper limit value or smaller, there are advantages in that the load when the first uplift portion 31 is removed can be reduced, and the plate member 3 and the processed member 5 which have high strength and favorable texture can be obtained. The thickness t′ of the first uplift portion 31 is more preferably 4 mm or smaller, further preferably 3 mm or smaller, and particularly preferably 2 mm or smaller.

The thickness t′ of the first uplift portion 31 is set to be a distance at a certain point on one main surface to the other main surface in a normal line in the first uplift portion 31 when the normal line is drawn with respect to a tangent line at the certain point.

The thickness t′ of the first uplift portion 31 is preferably thinner than the thickness t of the support portion 33. In the case where the thickness t′ of the first uplift portion 31 is thinner than the thickness t of the support portion 33, the first uplift portion 31 can be simply removed by the manufacturing method of the processed member 5, which will be described later, and a working load can be reduced. The thickness t′ of the first uplift portion 31 is preferably 90% or smaller, more preferably 85% or smaller, and further preferably 80% or smaller, with respect to the thickness t of the support portion 33.

The thickness t′ of the first uplift portion 31 is preferably 30% or greater with respect to the thickness t of the support portion 33. In this case, in the manufacturing method of the processed member 5, which will be described later, the processed member 5 can be efficiently manufactured without the occurrence of cracks, which may affect the entirety of the plate member 3, by polishing and grinding. The thickness t′ of the first uplift portion 31 is more preferably 40% or greater and further preferably 50% or greater, with respect to the thickness t of the support portion 33.

The width w₁ of the first uplift portion 31 on the first main surface 3a side is preferably 0.5 mm or greater. This is because, in the case where the plate member 3 is manufactured by forming the first uplift portion 31 through heating and shaping, when the plate member 3 is released from the used mold, the plate member 3 can be efficiently obtained while suppressing the damage of the first uplift portion 31. The width w₁ is more preferably 1 mm or greater and further preferably 2 mm or greater.

The width w₁ is preferably 10 mm or smaller. This is because the removal amount of the first uplift portion 31 can be reduced and the processed member 5 can be efficiently obtained, in the manufacturing method of the processed member 5 in the present invention, which will be described later. Furthermore, in the case of obtaining the small plate pieces 51, the number of the small plate pieces 51 per unit area can be increased and thus, the small plate pieces 51 can be efficiently obtained. The width w₁ is more preferably 8 mm or smaller and further preferably 5 mm or smaller.

The width w₂ of the first uplift portion 31 on the second main surface 3b side is preferably 0.5 mm or greater. This is because, in the case where the plate member 3 is manufactured by forming the first uplift portion 31 through heating and shaping, when the plate member 3 is released from the used mold, the plate member 3 can be efficiently obtained while suppressing the damage of the first uplift portion 31. The width w₂ is more preferably 1 mm or greater and further preferably 2 mm or greater.

The width w₂ is preferably 10 mm or smaller. This is because the removal amount of the first uplift portion 31 can be reduced and the opening member 53 can be efficiently obtained, in the manufacturing method of the processed member 5 in the present invention, which will be described later. Furthermore, in the case of obtaining the small plate pieces 51, the number of the small plate pieces 51 per unit area can be increased and thus, the small plate pieces 51 can be efficiently obtained. The width w₂ is more preferably 8 mm or smaller and further preferably 5 mm or smaller.

Each of the widths w₁ and w₂ of the first uplift portion 31 is set to be a distance between two points at which the height starts to change in the Z-direction in the curve C, based on an imaginary line connecting support portions 33 which are close to both sides of the first uplift portion 31, in the corresponding main surface in the thickness-direction sectional view of the plate member 3. In (b) of FIG. 1, the width w₁ means a distance between a point p₁ₐ and a point p₂ₐ, and the width w₂ means a distance between a point p_{1b} and a point p_{2b}.

When a vertical line L parallel to the Z-axis passing through the vertex M of the first uplift portion 31 is drawn, the shape of the first uplift portion 31 may be bilateral symmetrical or asymmetrical, in the thickness-direction sectional view of the plate member 3.

When a tangent line is drawn at the point p₁ₐ or p₂ₐ of the support portion 33, and another tangent line is drawn from the point p₁ₐ or p₂ₐ to the first main surface 3a of the first uplift portion 31, an angle formed on the first main surface 3a side among the formed angles is preferable larger than 90°, and more preferably 1000 or larger. This is because, when a fixing member such as an adhesive or another member such as a touch panel is assembled to or when a decoration such as a printing layer is formed on the obtained opening member 53 on the first main surface 5a side, a large opening can be maintained and thus, processing can be easily performed and yield ratio can be improved.

When a tangent line is drawn at the point p_{1b} or p_{2b} of the support portion 33, and another tangent line is drawn from the point p_{1b} or p_{2b} to the second main surface 3b of the first uplift portion 31, an angle formed on the first main surface 3a side among the formed angles is preferable larger than 90°, and more preferably 1000 or larger. This is because, when a printing of a character or the like, or a decoration such as an antiglare layer are performed on the obtained opening member 53 on the second main surface 5b side, or when adhering with another member, unevenness or bleeding, or trapping of air can be suppressed. Furthermore, when the obtained opening member 53 is used with a button of an electronic device or the like, the projected area in a top-view can be reduced and thus, undesired contact to an adjacent frame member or another member can be avoided and damage or breaking can be suppressed.

Two or more first uplift portions 31 may be provided in the same plate member 3. In this case, in the manufacturing method of the processed member 5, which will be described later, a plurality of first uplift portions 31 can be removed at once by polishing and grinding, and the opening member 53 with multiple openings and a plurality of small plate pieces 51 can be efficiently manufactured.

In the case where two or more first uplift portions 31 are provided, a distance N between vertices of the first uplift portions 31 is not particularly limited and is preferably 10 mm or smaller at a place at which the first uplift portions are closest to each other. A portion in the support portion 33, which is to be a structural portion 333, has an influence on strength of the entirety of the plate member 3. As the distance N becomes shorter, the structural portion 333 is thin and strength of the entirety of the plate member 3 is also decreased. Thus, in the conventional method, such a thin structural portion 333 is broken and a processed member 5 having the thin structural portion 333 cannot be formed. In the manufacturing method of the processed member 5 in the present invention, which will be described later, even though the structural portion 333 is thin, the first uplift portion 31 can be removed without applying a load. Thus, the opening member 53 having a thin structural portion 333 can be simply and efficiently obtained. The distance N at the place at which the first uplift portions are closest to each other is more preferably 8 mm or smaller and further preferably 5 mm or smaller.

The lower limit value of the distance N at the place at which the first uplift portions are closest to each other is preferably 0.2 mm or greater. In the thin structural portion 333 which is smaller than the lower limit value, even though the opening member 53 can be formed in the manufacturing method of the processed member 5 in the present invention, which will be described later, the strength of the opening member 53 itself may be not secured, making it difficult to use the opening member 53 as the final product. The distance N at the place at which the first uplift portions are closest to each other is more preferably 0.5 mm or greater and further preferably 1 mm or greater.

### Support Portion 33

The support portion 33 is adjacent and connected to the first uplift portion 31 and is a part of the structure of the plate member 3. The support portion 33 is divided into a removal portion 331 and the structural portion 333. The removal portion 331 is removed in the manufacturing method of the processed member 5 in the present invention, which will be described later, and processed into the small plate piece 51 as necessary. The structural portion 333 constitutes a structural portion 533 of the finally obtained opening member 53.

The thickness t of the support portion 33 is preferably set to be thickness T of the plate 1 or smaller.

The thickness t is preferably 0.2 mm or greater. In the case of the support portion 33 having a thickness which is the lower limit value or greater, even in the manufacturing method of the processed member 5, which will be described later, the opening member 53 or the small plate piece 51 can be efficiently formed. The strength of the finally obtained processed member 5 can also be secured. The thickness t of the support portion 33 is more preferably 0.4 mm or greater, further preferably 0.5 mm or greater, and particularly preferably 0.7 mm or greater.

The upper limit value of the thickness t is preferably 5 mm or smaller. In the case where thickness t of the support portion 33 is the upper limit value or smaller, reduction in weight can be achieved and the processed member 5 having high strength and favorable texture can be obtained. The thickness t of the support portion 33 is more preferably 4 mm or smaller, further preferably 3 mm or smaller, and particularly preferably 2 mm or smaller.

The thickness t of the support portion 33 is a distance of the plate member 3 in Z-direction. The thickness t may be an average value of a distance at a certain point on one main surface to the other main surface in a normal line in the thickness-direction sectional view of the plate member 3 when the normal line is drawn with respect to a tangent line at the certain point.

In the thickness-direction sectional view of the plate member 3, the support portion 33 may maintain the same shape as the plate 1 or may be deformed from the shape of the plate 1. For example, the first main surface 3a of the support portion 33 can be appropriately deformed, for example, a part of the second main surface 3b of the support portion 33 is bent while maintaining the shape of the plate 1. For example, deformation of the second main surface 3b of the support portion 33 may be performed in a forming step when the first uplift portion 31 is formed; or after the opening member 53 is formed, the end surface 535 of the opening portion 531 may be deformed by being processed, for example, polished and ground. The deformation is not particularly limited.

### Alignment Mark 35

In the manufacturing method of the processed member 5 in the present invention, which will be described later, the alignment mark 35 has an alignment function for cutting or processing the plate member 3 or a function of checking front and back sides and product lots. In (a) FIG. 1, a first alignment mark 351 and a second alignment mark 353 are formed on an outer edge side of the plate member 3.

The alignment mark 35 can be formed to be lower than the height of the first main surface 3a of the plate member 3 (e.g., a recessed portion is formed on the first main surface 3a of the plate member 3). In the manufacturing method of the processed member 5, which will be described later, when the first uplift portion 31 is removed by, for example, polishing or grinding, the alignment mark 35 formed to be higher than the first main surface 3a may also be scrapped. If the alignment mark 35 is formed at a position lower than the height of the first main surface 3a, such a problem can be solved.

The alignment mark 35 can be formed to be higher than the height of the first main surface 3a of the plate member 3 (e.g., a protrusion portion is formed on the first main surface 3a of the plate member 3). In the manufacturing method of the processed member 5, which will be described later, when positioning is performed by using the alignment mark 35 and then the first uplift portion 31 is removed by, for example, polishing or grinding, the alignment mark 35 can be removed along with removal of the first uplift portion 31. Thus, the alignment mark 35 having a function of positioning can be removed in a post-step. Accordingly, the alignment mark 35 does not remain on the final product.

Two or more alignment marks 35 may be formed, for example, the first alignment mark 351 and the second alignment mark 353 as in (a) of FIG. 1. In a plurality of post-steps, positioning and the like can be performed with an alignment mark 35 suitable for each of the steps.

The alignment mark 35 can be formed by processing the plate 1 or the plate member 3. For example, the alignment mark 35 can be formed when the first uplift portion 31 is formed by heating and shaping the plate 1 as described later. Consecutively, the alignment mark 35 can be also formed on the obtained plate member 3 by printing, laser processing or the like.

In the case where the alignment mark 35 is formed in the plate 1 by heating and shaping, for example, a hook-like projection portion is formed in the mold to be used. In this case, the hook-like projection portion is transferred to the plate 1, to form the second alignment mark 353 which is a hook-like recess portion on the plate member 3 obtained. In the case where vacuum shaping is used in the heating and shaping, an exhaust hole formed in the mold to be used is transferred to the plate 1, to form the first alignment mark 351 which is a hemispherical projection portion on the plate member 3 obtained.

As illustrated in (a) of FIG. 2, the first alignment mark 351 may be formed on the first uplift portion 31. Thus, in the manufacturing method of the processed member 5, which will be described later, the first alignment mark 351 which is used for positioning and then becomes unnecessary can be efficiently removed by removing the first uplift portion 31. As illustrated in (b) of FIG. 2, the first alignment mark 351 may be formed on an outside, when viewed from the center of the plate member 3, of an imaginary line indicated by a one-dot chain line formed in the second alignment mark 353.

### Base Portion 313

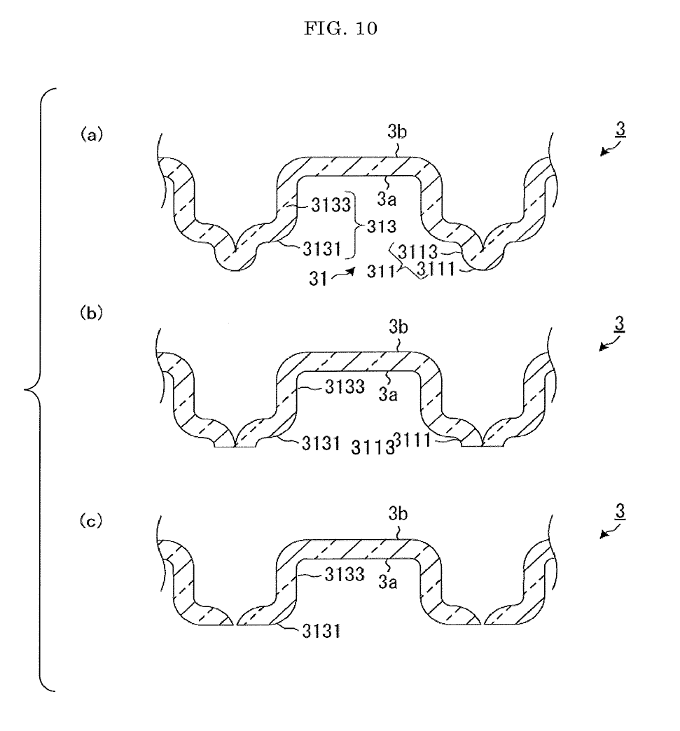

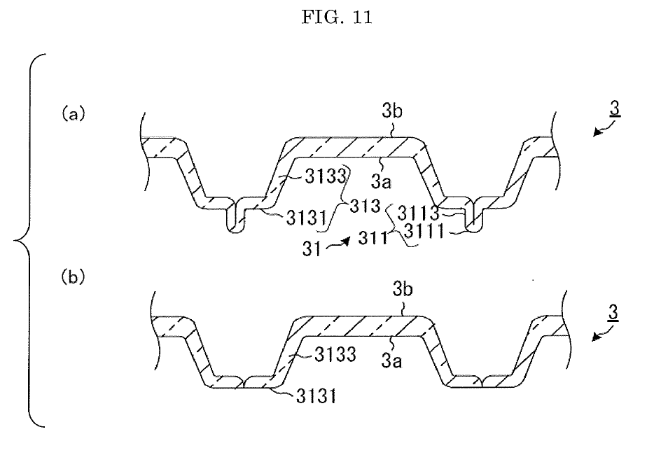

In addition, the first uplift portion 31 may have a base portion 313 and a protrusion portion 311 (see FIG. 10 and FIG. 11). In the thickness-direction sectional view of the plate member 3, the base portion 313 is formed to be a projection portion on the first main surface 3a, and to cause a portion corresponding to the projection portion, in the second main surface 3b, to be a recess portion. At this time, the protrusion portion 311 is formed on the base portion 313. The base portion 313 may have a side surface portion 3133 and a flat portion 3131 or may have only the side surface portion 3133. It is not particularly limited. The protrusion portion 311 has a side surface portion 3113 and a top portion 3111.

### Second Uplift Portion 39

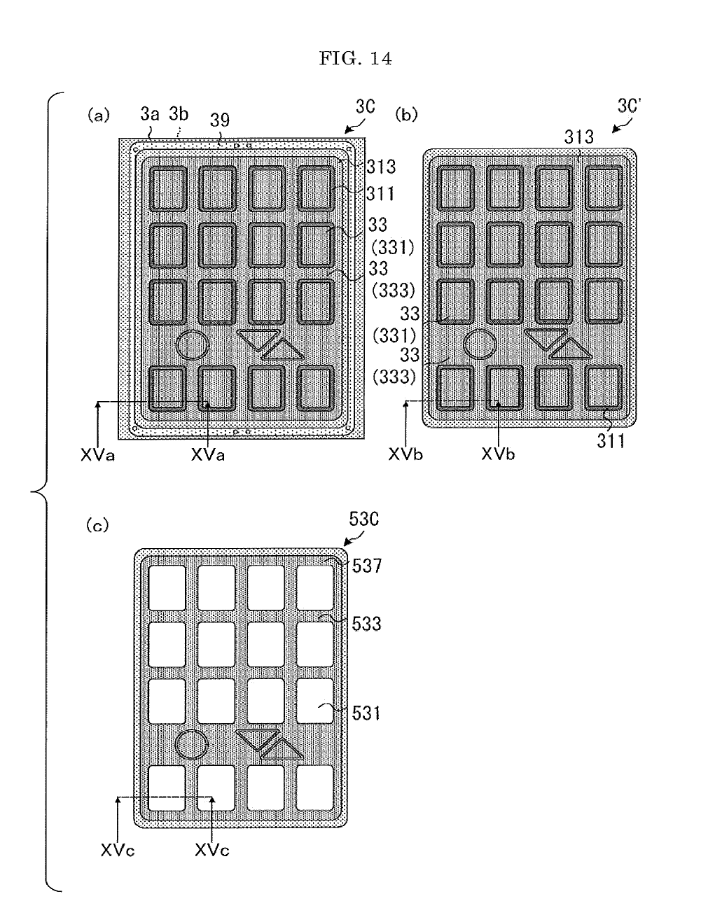

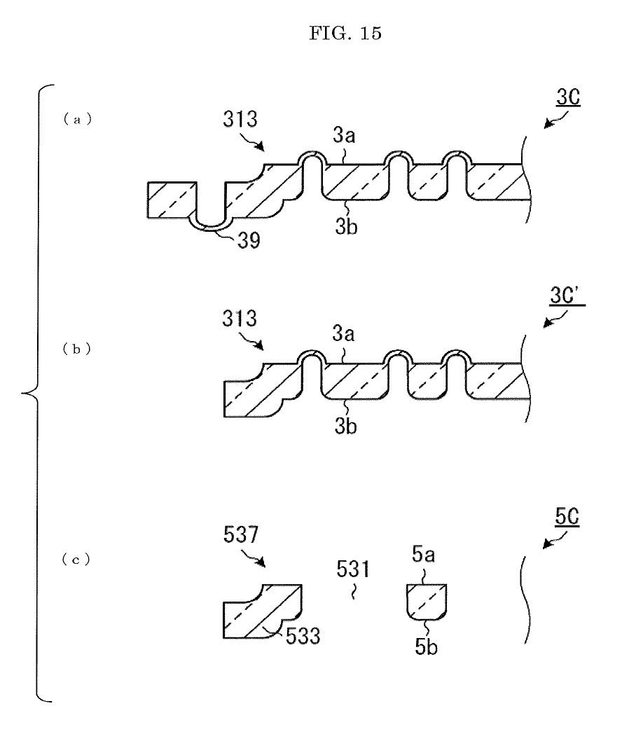

The plate member 3 may also has a second uplift portion 39 projecting in an opposite direction of the first uplift portion 31 in the Z-direction (see FIG. 14 and FIG. 15). That is, in the thickness-direction sectional view of the plate member 3, the second uplift portion 39 is formed to be a projection portion on the second main surface 3b and to cause a portion corresponding to the projection portion, in the first main surface 3a, to be a recess portion.

A forming method or features of the second uplift portion 39 are not particularly limited and are preferably similar to those in the case of the first uplift portion 31.

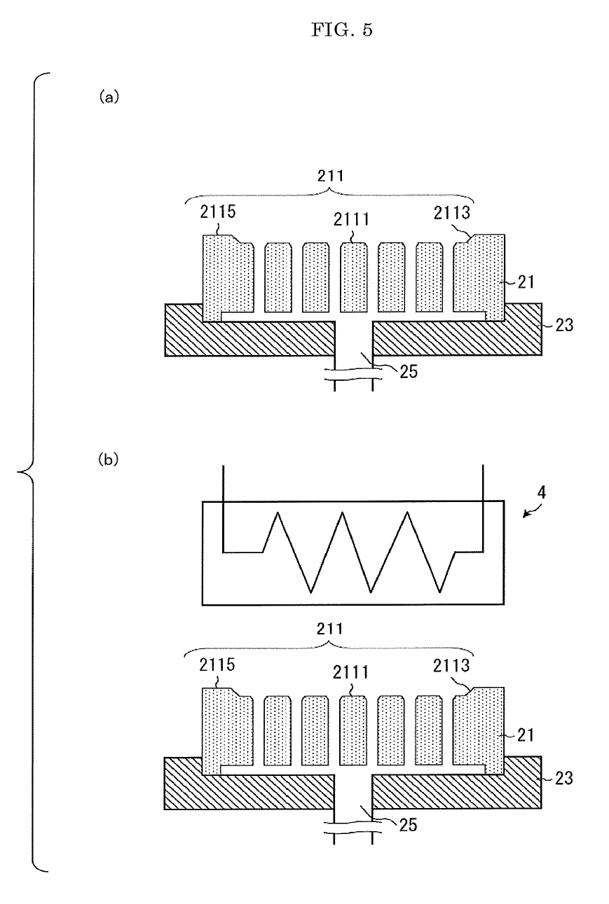

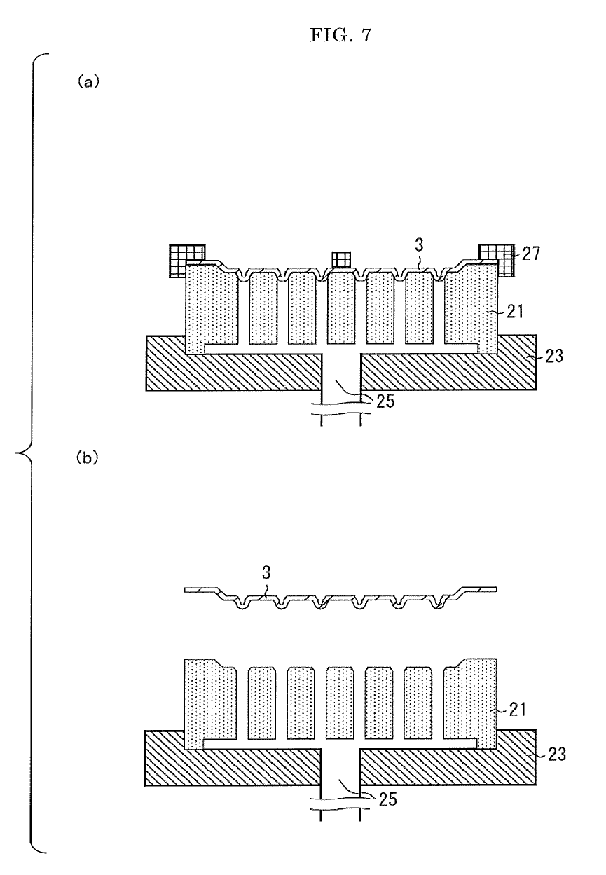

A surface of the plate member 3, which comes into contact with a shaping surface 211 (see FIG. 5 and FIG. 7) of the shaping die 21 in a forming step which will be described later is preferably set to be the first main surface 3a.

Arithmetic mean roughness and arithmetic mean waviness of the first main surface 3a in the support portion 33 are respectively set as Ra₍ₐ₎ and Wa₍ₐ₎, and arithmetic mean roughness and arithmetic mean waviness of the second main surface 3b are respectively set as Ra_{(b)} and Wa_{(b)}. Ra and Wa are values measured by a method defined based on JIS B 0601 (2013).

The arithmetic mean roughness Ra₍ₐ₎ of the first main surface 3a is preferably 1 μm or smaller and further preferably 0.1 μm or smaller.

The arithmetic mean waviness Wa₍ₐ₎ of the first main surface 3a is preferably 1 μm or smaller and further preferably 0.1 μm or smaller.

The arithmetic mean roughness Ra_{(b)} of the second main surface 3b is preferably 1 μm or smaller and further preferably 0.1 μm or smaller

The arithmetic mean waviness Wa_{(b)} of the second main surface 3b is preferably 1 μm or smaller and further preferably 0.1 μm or smaller.

Ra₍ₐ₎, Ra_{(b)}, Wa₍ₐ₎, and Wa_{(b)} preferably have a relation of Formulas (1) and (2).

Ra₍ₐ₎>Ra_{(b)} (1)

Wa₍ₐ₎>Wa_{(b)} (2)

In the case where the above-mentioned relations are satisfied, when the processed member 5 is used for the final product such that the first main surface 3a of the plate member 3 is set as a surface to be touched by a user (described as “an outer surface” below), dazzling can be reduced by scattering external light, and adhesion of dirt such as fingerprints can be reduced due to an uneven surface. At this time, the second main surface 3b is a surface included in the final product (described as “an inner surface” below). Since the second main surface 3b is a flat surface, disconnection hardly occurs even when a circuit is formed thereon, for example.

Conversely, in the case where the above-mentioned relations are satisfied, when the processed member 5 is used for the final product such that the first main surface 3a of the plate member 3 is set to be the inner surface, an adhesive or a printing layer can be firmly fixed. At this time, the second main surface 3b is an outer surface and a flat surface. Thus, favorable aesthetics can be obtained.

Arithmetic mean roughness and arithmetic mean waviness of the first main surface 3a in the first uplift portion 31 are respectively set as Ra₍ₐ₎′ and Wa₍ₐ₎′. Ra₍ₐ₎′ and Wa₍ₐ₎′ preferably have a relation of Formulas (3) and (4).

Ra₍ₐ₎>Ra₍ₐ₎′ (3)

Wa₍ₐ₎>Wa₍ₐ₎′ (4)

This is because contrast between the first uplift portion 31 and the support portion 33 is easily provided, and thus the first uplift portion 31 also has a function similar to the alignment mark 35 and positioning can be easily performed.

The arithmetic mean roughness Ra₍ₐ₎′ of the first uplift portion 31 is preferably 1 μm or smaller and further preferably 0.1 μm or smaller. The arithmetic mean waviness Wa₍ₐ₎′ of the first uplift portion 31 is preferably 1 m or smaller and further preferably 0.1 μm or smaller.

Arithmetic mean roughness and arithmetic mean waviness of the first main surface 3a in the alignment mark 35 are respectively set as Ra₍ₐ₎″ and Wa₍ₐ₎″. Ra₍ₐ₎″ and Wa₍ₐ₎″ preferably have a relation of Formulas (5) and (6).

Ra₍ₐ₎>Ra₍ₐ₎″ (5)

Wa₍ₐ₎>Wa₍ₐ₎″ (6)

This is because, in the case where positioning is performed with the alignment mark 35 by using a camera or the like, contrast between the support portion 33 and the alignment mark 35 is easily provided, and positioning is easily and precisely performed.

The arithmetic mean roughness Ra₍ₐ₎″ of the alignment mark 35 is preferably 1 μm or smaller and further preferably 0.1 μm or smaller. The arithmetic mean waviness Wa₍ₐ₎″ of the alignment mark 35 is preferably 1 μm or smaller and further preferably 0.1 μm or smaller.

A measuring method of the roughness is not particularly limited. For example, regarding the main surface of the support member 33 which are used as the outer surface of the processed member 5 after processing, root mean square roughness Rq is preferably 0.3 nm to 10 μm from a viewpoint of roughness and a finger slip property; maximum height roughness Rz is preferably 0.5 nm to 10 μm from a viewpoint of the roughness and the finger slip property; maximum section height roughness Rt is preferably 0.5 nm to 5 μm from the roughness and the finger slip property; maximum peak height roughness Rp is preferably 0.3 nm to 5 μm from a viewpoint of the roughness and the finger slip property; and maximum valley depth roughness Rv is preferably 0.3 nm to 5 μm from a viewpoint of the roughness and the finger slip property. Average length roughness Rsm is preferably 0.3 nm to 10 μm from a viewpoint of the roughness and the finger slip property. Kurtzys roughness Rku is preferably 1 to 30 from a viewpoint of the tactile sensation.

Skewness roughness Rsk is preferably −1 or more and 1.3 or less from a viewpoint of visibility, uniformity of the tactile sensation and the like. Here, the Skewness roughness Rsk of the roughness curve R indicates a mean cubic height Z (x) in a standard length that is a dimensionless value using the cube of the root mean square height Zq, and is an index displaying the existing bias in uneven shape with respect to an average line. When the Skewness roughness Rsk of the roughness curve R is a positive value (Rsk>0), the uneven shape tends to slant to a concave manner, resulting in a keen convex. When the Skewness roughness Rsk of the roughness curve R is a negative value (Rsk<0), the uneven shape tends to slant to a convex manner, resulting in a blunt convex. The roughness curve having a blunt convex results a smaller haze value than that having a keen convex. In the case where the Skewness roughness Rsk is the upper limit value or less, excellent antiglare properties and tactile sensation can be maintained and also haze can be lowered. Furthermore, in the case where the processed member 5 is used as the outer surface which is a surface to be touched by a user, the Skewness roughness Rsk is more preferably −1 or more and 1 or less. This is because in the case where the Skewness roughness Rsk is 1 or less, fingerprint, if attached can be easily removed.

These types of roughness are the roughness based on the roughness curve R. The roughness may be defined by the undulation W or the cross-sectional curve P generated in correlation with the roughness curve. It is not particularly limited.

### Processed Member 5

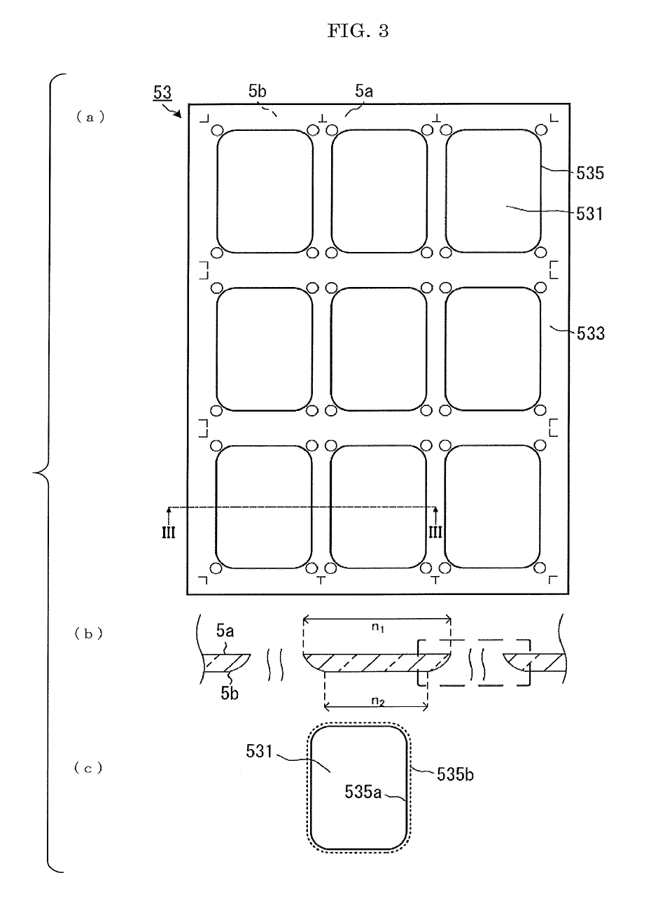

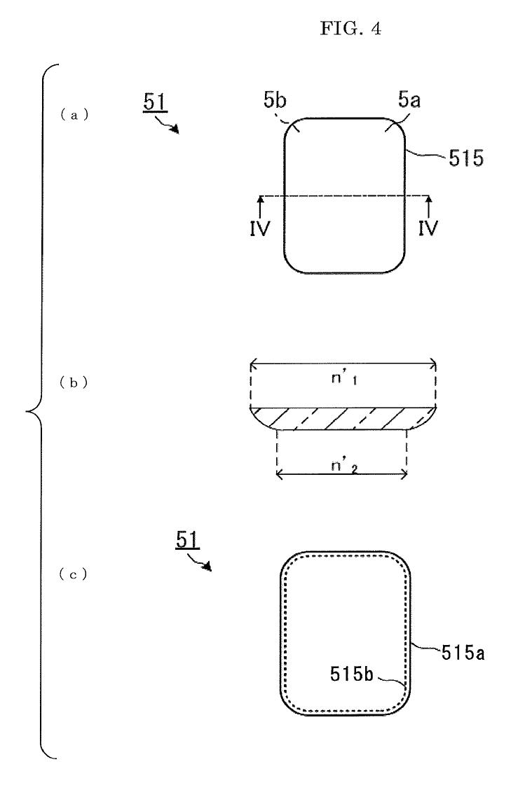

The processed member 5 in the present invention has a first main surface 5a and a second main surface 5b. The processed member 5 is a member obtained by processing the above-described plate member 3. Specifically, the opening member 53 as illustrated in FIG. 3 and the small plate piece 51 as illustrated in FIG. 4 can be exemplified as the processed member 5.

### Opening Member 53

An example of the opening member 53 in the present invention has a substantially rectangular shape, as illustrated in FIG. 3. The opening member 53 includes a plurality of opening portions 531 aligned and arranged in the XY-directions and the structural portion 533 which forms and supports the opening portion 531. The opening member 53 will be described based on an embodiment having a substantially rectangular shape in a plan view. The shape of opening member 53 is not particularly limited and may be circular or polygonal.

### Structural Portion 533

The structural portion 533 is the structural portion 333 of the plate member 3. The structural portion 533 is a portion that supports the structure so as to form the opening portion 531, when the first uplift portion 31 is removed by, for example, polishing or grinding in the manufacturing method of the processed member 5, which will be described later.

(a) of FIG. 3 is a diagram illustrating the opening member 53 having two or more opening portions 531 in a top view. At this time, in the sectional view of III-III portion of the opening member 53 ((b) of FIG. 3), the width n₁ of the structural portion 533 on the first main surface 5a side is preferably different from the width n₂ of the structural portion 533 on the second main surface 5b side.

The width n₁ on the first main surface 5a is preferably 10 mm or smaller at a place at which the opening portions are closest to each other. The structural portion 533 has an influence on strength of the entirety of the opening member 53. As the structural portion 533 becomes thinner, strength of the entirety of the opening member 53 is also decreased. Thus, in the conventional method, such a thin structural portion 533 is broken and an opening member 53 having the thin structural portion 533 cannot be formed. In the manufacturing method of the processed member 5, which will be described later, even though the structural portion 533 is thin, the first uplift portion 31 can be removed without applying a load. Thus, the opening member 53 having a thin structural portion 533 is simply and efficiently obtained. Designability of the final product can be improved by reducing the distance between the opening portions 531. The width n₁ at the place at which the opening portions are closest to each other is more preferably 5 mm or smaller and further preferably 2 mm or smaller.

Regarding the width n₁ of the structural portion 533 at the place at which the opening portions are closest to each other, the lower limit value is preferably 0.5 mm or greater. In the thin structural portion 533 which is smaller than the lower limit value, the strength of the opening member 53 itself may be not secured, making it difficult to use the opening member 53 as the final product. The width n₁ at the place at which the opening portions are closest to each other is more preferably 0.8 mm or greater and further preferably 1 mm or greater.

The width n₂ on the second main surface 5b is preferably 10 mm or smaller at a place at which the opening portions are closest to each other. The structural portion 533 has an influence on strength of the entirety of the opening member 53. As the structural portion 533 becomes thinner, strength of the entirety of the opening member 53 is also decreased. Thus, in the conventional method, such a thin structural portion 533 is broken and an opening member 53 having the thin structural portion 533 cannot be formed. In the manufacturing method of the processed member 5, which will be described later, even though the structural portion 533 is thin, the first uplift portion 31 can be removed without applying a load. Thus, the opening member 53 having a thin structural portion 533 is simply and efficiently obtained. Designability of the final product can be improved by reducing the distance between the opening portions 531. The width n₂ at the place at which the opening portions are closest to each other is more preferably 5 mm or smaller and further preferably 2 mm or smaller.

Regarding the width n₂ of the structural portion 533 at the place at which the opening portions are closest to each other, the lower limit value is preferably 0.5 mm or greater. In the thin structural portion 533 which is smaller than the lower limit value, the strength of the opening member 53 itself may be not secured, making it difficult to use the opening member 53 as the final product. The width n₂ at the place at which the opening portions are closest to each other is more preferably 0.8 mm or greater and further preferably 1 mm or greater.

In the case where the width n₁ on the first main surface 5a side is different from the width n₂ on the second main surface 5b side, regarding a projection shape formed by the end surface 535 of the opening portion 531 in a top view of the opening member 53, the projection shape of the first main surface 5a side is different from the projection shape of the second main surface 5b side, as illustrated in (c) of FIG. 3.

The thickness of the structural portion 533 is preferably set to be thickness t of the support portion 33 of the plate member 3 or smaller.

The thickness of the structural portion 533 is preferably 0.2 mm or greater. The structural portion 533 having a thickness of this lower limit value or greater can secure the strength of the finally obtained processed member 5. The thickness of the structural portion 533 is more preferably 0.4 mm or greater, further preferably 0.5 mm or greater, and particularly preferably 0.7 mm or greater.

The upper limit value of the thickness of the structural portion 533 is preferably 5 mm or smaller. In the case where thickness of the structural portion 533 is the upper limit value or smaller, reduction in weight can be achieved and the processed member 5 having high strength and favorable texture can be obtained. The thickness of the structural portion 533 is more preferably 4 mm or smaller, further preferably 3 mm or smaller, and particularly preferably 2 mm or smaller.

The thickness of the structural portion 533 is a distance of the processed member 5 in Z-direction. The thickness may be an average value of a distance at a certain point on one main surface to the other main surface in a normal line in the thickness-direction sectional view of the processed member 5 when the normal line is drawn with respect to a tangent line at the certain point.

(c) of FIG. 3 illustrates a projection shape formed by the end surface 535 of the opening portion 531, which is surrounded by a dotted line in (b) of FIG. 3, in a top view of the opening member 53. A shape 535a formed by the end surface on the first main surface 5a side is preferably included in a shape 535b formed by the end surface on the second main surface 5b side.

In the case where the opening member 53 having the opening portion 531 in a top view as illustrated in (c) of FIG. 3 is incorporated in the final product and the second main surface 5b is set to be the outer surface, a gentle curved surface is provided in the vicinity of the end surface 535 of the structural portion 533 and the opening member 53 can be gently deformed. Thus, physical strength can be secure and the aesthetic appearance can be improved. In this case, the first main surface 5a is set to be the inner surface and the first main surface 5a is substantially flat. Therefore, a printing layer for decoration can be easily formed and the aesthetic appearance can be improved on both the main surfaces. Furthermore, in the case where a display panel such as an organic electroluminescent (EL) display panel is attached to the first main surface 5a, the display panel can be attached with a high accuracy and visibility of the display panel can be improved when viewed from the second main surface 5b from outside by a user.

In the case where the opening member 53 having a sectional structure as illustrated in (b) of FIG. 3 is incorporated in the final product and the first main surface 5a is set to be the outer surface, the structural portion 533 is substantially flat and a surface which is flush with another surface can be obtained by adjusting the height of the member such as the small plate piece 51 fit to the opening portion 531, that is, a so-called flush surface can be obtained. In the case where the flush member is used as an exterior member of a transportation machine, the exterior member can achieve low air resistance. Furthermore, in the case where a display panel such as an organic EL display panel is attached to the second main surface 5b, the display panel can be made to face toward a user by utilizing the curved surface in the vicinity of the end surface 535 of the second main surface 5b, and visibility of the display panel can be improved when viewed from the first main surface 5a from outside by the user.

The opening member 53 may have a base portion 537 and the opening portion 531 may be formed on the base portion 537.

The plate, the base portion 537, the structural portion 533, and the like of the opening member 53 have features which are similar to those of the corresponding portions of the plate member 3. Thus, descriptions will not be repeated.

### Small Plate Piece 51

An example of the small plate piece 51 in the present invention has a substantially rectangular shape, as illustrated in FIG. 4. The small plate piece 51 will be described based on an embodiment having a substantially rectangular shape in a plan view. The shape of the small plate piece 51 is not particularly limited and may be circular or polygonal.

(a) of FIG. 4 is a diagram illustrating the small plate piece 51 in a top view. In the sectional view of IV-IV portion of the small plate piece 51 ((b) of FIG. 4), the width n′₁ of the small plate piece 51 on the first main surface 5a side is preferably different from the width n′₂ of the small plate piece 51 on the second main surface 5b side.

The width n′₁ on the first main surface 5a side is preferably 30 mm or smaller. In the conventional method, small pieces of thin glass are broken when producing and thus, it is not possible to efficiently manufacture the small plate piece 51. In the manufacturing method of the processed member 5, which will be described later, the first uplift portion 31 can be removed from the plate member 3 without applying a load. Thus, the thin and small plate piece 51 is simply and efficiently obtained. The width n′₁ is more preferably 20 mm or smaller and further preferably 15 mm or smaller.

The lower limit value of the width n′₁ is preferably 0.5 mm or greater. In the case of the small plate piece 51 which is smaller than the lower limit value, the strength is not secured and it is difficult to use the small plate piece 51 as the final product. The width n′₁ is more preferably 0.8 mm or greater and further preferably 1 mm or greater.

The width n′₂ on the second main surface 5b side is preferably 30 mm or smaller. In the conventional method, small pieces of thin glass are broken when producing and thus, it is not possible to efficiently manufacture the small plate piece 51. In the manufacturing method of the processed member 5, which will be described later, the first uplift portion 31 can be removed from the plate member 3 without applying a load. Thus, the thin and small plate piece 51 is simply and efficiently obtained. The width n′₂ is more preferably 20 mm or smaller and further preferably 15 mm or smaller.

The lower limit value of the width n′₂ is preferably 0.5 mm or greater. In the case of the small plate piece 51 which is smaller than the lower limit value, the strength is not secured and it is difficult to use the small plate piece 51 as the final product. The width n′₂ is more preferably 0.8 mm or greater and further preferably 1 mm or greater.

In the case where the width n′₁ on the first main surface side 5a is different from the width n′₂ on the second main surface 5b, regarding a projection shape formed by the end surface 515 of the small plate piece 51 in a top view of the small plate piece 51 viewed from the first main surface 5a side, the projection shape on the first main surface 5a side is different from the projection shape on the second main surface 5b side, as illustrated in (c) of FIG. 4.

A shape 515b formed by the end surface on the second main surface 5b side is preferably included in a shape 515a formed by the end surface on the first main surface 5a side, in a top view of the small plate piece 51.

In the case where the small plate piece 51 having a top view as illustrated in (c) of FIG. 4 is incorporated in the final product and the second main surface 5b is set to be the outer surface, a gentle curved surface is provided in the vicinity of the end surface 515 of the small plate piece 51 and the small plate piece 51 can be gently deformed. Thus, physical strength can be secure and the aesthetic appearance can be improved. In this case, the first main surface 5a is set to be the inner surface and the first main surface 5a is substantially flat. Therefore, a printing layer for decoration can be easily formed and the aesthetic appearance can be improved on both the main surfaces.

In the case where the small plate piece 51 having a sectional structure as illustrated in (b) of FIG. 4 is incorporated in the final product and the first main surface 5a is set to be the outer surface, the small plate piece 51 is substantially flat and a surface which is flush with another surface can be obtained by adjusting the heights of other members, that is, a so-called flush surface can be obtained.

In the top view of the small plate piece 51 from the first main surface 5a, a curvature radius at the corner portion is preferably 50 mm or less, more preferably 10 mm or less, and further preferably 5 mm or less. This is because when a plurality of the small plate pieces 51 are aligned, gaps formed among the corners of the aligned small plate pieces 51 can be reduced to provide an excellent external appearance. In addition, this is because the end portion of the small plate piece 51 can be easily recognized only by a tactile sense without visual contact.

In the top view of the small plate piece 51 from the first main surface 5a, the curvature radius at the corner portion is preferably 0.5 mm or more, more preferably 1 mm or more, and further preferably 2 mm or more. This is for suppressing the occurrence of breaking during processing.

In the top view of the small plate piece 51 from the second main surface 5b, a curvature radius at the corner portion is preferably 50 mm or less, more preferably 10 mm or less, and further preferably 5 mm or less. This is because when a plurality of the small plate pieces 51 are aligned, gaps formed among the corners of the aligned small plate pieces 51 can be reduced to provide an excellent external appearance. In addition, this is because the end portion of the small plate piece 51 can be easily recognized only by a tactile sense without visual contact.

In the top view of the small plate piece 51 from the second main surface 5b, the curvature radius at the corner portion is preferably 0.5 mm or more, more preferably 1 mm or more, and further preferably 2 mm or more. This is for suppressing the occurrence of breaking during processing.

In a thickness-direction sectional view of the small plate piece 51, a curvature radius of the end surface 515 at the second main surface 5b side is preferably 50 mm or less, more preferably 30 mm or less, and further preferably 10 mm or less. This is because the angle of the end surface to be connected to the surface on the first main surface 5a side becomes large. Therefore, the strength of the small plate piece 51 can be maintained, and a risk of cutting a user's finger or the like can be reduced.

In a thickness-direction sectional view of the small plate piece 51, the curvature radius of the end surface 515 at the second main surface 5b side is preferably 0.1 mm or more, more preferably 1 mm or more, and further preferably 2 mm or more. This is because in the case where the curvature radius at the second main surface 5b side is less than the lower limit value, since the thickness is thin, the end surface easily be a keen edge. By setting the curvature radius at the second main surface 5b side to be the lower limit value or more, in the case where the small plate piece 51 is used as a contact member such as a button, it does not bring an uncomfortable feeling.

In the thickness-direction sectional view of the small plate piece 51, a curvature radius of the end surface 515 at the first main surface 5a side is preferably 3 mm or less, more preferably 2 mm or less, further preferably 1 mm or less, and particularly preferably 0.5 mm or less. This is because when the small plate piece 51 is decorated by printing or attached with a sensor or display, the gap between the end surface of the small plate piece 51 at the first main surface 5a side and the surface on which the printing and attaching are not performed can be reduced and thus, designability can be enhanced.

In the thickness-direction sectional view of the small plate piece 51, the curvature radius of the end surface 515 at the first main surface 5a side is preferably 0.01 mm or more, more preferably 0.05 mm or more, further preferably 0.1 mm or more, and particularly preferably 0.3 mm or more. This is for suppressing the breaking or cracking such as chipping when the small plate piece 51 is handled or used as a product.

The thickness of the small plate piece 51 is preferably 5 mm or less, more preferably 3 mm or less, and further preferably 1 mm or less. This is because when the small plate piece 51 is used in a device by combining a touch sensor, the sensitivity of the sensor can be enhanced, weight of the device in which the small plate piece 51 is incorporated as a product can be reduced, and designability of the device using the small plate piece 51 can be maintained.

The thickness of the small plate piece 51 is preferably 0.2 mm or more, more preferably 0.3 mm or more, further preferably 0.5 mm or more and particularly preferably 0.7 mm or more. This is for suppressing the occurrence of breaking during processing and for maintaining the strength during use.

A projection portion or a recess portion may be formed on the small plate piece 51, for allowing a position to be recognized only by a tactile sense in the final product, for forming a desired character or graphic design, or for arranging a biometric identification sensor such as a fingerprint sensor or arranging a device having a light guiding function such as a LED. Specifically, protrusions such as braille are exemplified.

The small plate piece 51 may have a through-hole. Metal, a ceramic, a colored glass, or a device such as a sensor may be placed in the through-hole.

The small plate piece 51 is not limited to the rectangular shape as illustrated in FIG. 4. For example, the small plate piece 51 may have a sectional shape having a side surface portion 3133 as illustrated in FIG. 10. Moreover, the small plate piece 51 may be curved in a whole, may include a bent portion as a part, or may have an uneven thickness.

### Manufacturing Method of Processed Member 5

The manufacturing method of the processed member 5 in the present invention includes a step of removing the first uplift portion 31 of the plate member 3 in which one or more first uplift portions 31 and the support portion 33 connected to the circumferential portions of the first uplift portion 31 are formed in the plate 1 having the first main surface 1a and the second main surface 1b (removal step). The manufacturing method of the processed member 5 may further include a forming step of manufacturing the plate member 3 from the plate 1. The removal step only has to include removing the first uplift portion 31, and the support portion may be partially removed.

### Forming Step

The plate member 3 is manufactured in a manner that the one or more first uplift portions 31 and the support portion 33 are formed by using the above-described plate 1. A method of forming the first uplift portion 31 and the support portion 33 is not particularly limited. Heating and shaping in which the plate 1 is deformed by heating can be used.

### Heating and Shaping

Heating and shaping are not particularly limited so long as the plate 1 can be deformed by heating. A vacuum shaping method, a press shaping method, a self-weight shaping method, and the like can be used.

A manufacturing method of manufacturing the plate member 3 from the plate 1 by the vacuum shaping method will be described with reference to FIG. 5 to FIG. 7.

As illustrated in (a) of FIG. 5, the shaping die 21 in which a plurality of uneven shaping surfaces 211 having the same surface shape as a design shape of the plate member 3 is provided on the top surface is prepared. The shaping die 21 is fixed to a base 23. A suction passage 25 connected to a vacuum device (not illustrated) is provided between the shaping die 21 and the base 23.

The shaping surface 211 has an uneven section having a shallow depth. A bottom surface 2111 and a top surface 2115 of the shaping surface 211 are continuous by the side surface 2113. The side surface 2113 may be a curved surface or a flat surface. If the side surface 2113 is a curved surface, the residual gas can be easily removed and thus, the plate member 3 having a shaping surface with few defects can be easily obtained.

As the material of the shaping die 21, a carbon material, a glass material such as fused silica, or a ceramic material is preferable. These materials are useful for suppressing the occurrence of the transfer trace due to the shaping die 21. A film of Si₃N₄, SiO₂, SiC, Al₂O₃, Pt, Ir, W, Re, Ta, Rh, Ru, Os, C, Ta, Ti, Ni, BN, or the like may be provided on the shaping surface 211. The film contributes to improvement of releasability between the plate member 3 and the shaping die 21.

Surface roughness of the shaping surface 211 of the shaping die 21 is not particularly limited. Arithmetic mean roughness Ra thereof is preferably 2.5 μm or smaller and arithmetic mean waviness Wa thereof is preferably 1.6 μm or smaller. In the case where these conditions are satisfied, even though the roughness of the shaping surface 211 of the shaping die 21 is transferred to the plate member 3, the plate member 3 having excellent external appearance can be obtained. Arithmetic mean roughness Ra of the shaping surface 211 is more preferably 1 μm or smaller and arithmetic mean waviness Wa is more preferably 0.4 μm or smaller.

In the shaping surface 211 of the shaping die 21, the surface roughness may be partially changed. For example, in order to transfer a desired character to the plate member 3, the surface roughness of the shaping surface 211 may be changed so as to form the mirrored character of the desired character. In order to form desired recess and projection portions in the plate member 3, the corresponding projection and recess portions may be formed on the shaping surface 211.

Then, as illustrated in (b) of FIG. 5, the shaping die 21 is pre-heated up to 50° C. to 500° C. by a heater 4. In a state where the temperature of the plate 1 is lower than the temperature of the shaping die 21, the first main surface 1a of the plate 1 is placed on the shaping die 21 so as to come into contact with the shaping die 21 as illustrated in (a) of FIG. 6. After the plate 1 is placed on the shaping die 21, the outer circumferential portion of the plate 1 is preferably bound to the top surface 2115 of the shaping die 21 by a binding tool 27.

As the binding tool 27, a jig having a clamp mechanism, a weight, or the like can be used. The plate 1 may be sandwiched between the shaping die 21 and the binding tool 27. The plate 1 can be also bounded to the shaping die 21 by vacuum. If the plate 1 is bound by the binding tool 27, jumping of the outer circumferential portion during shaping can be effectively prevented.

As a material of the binding tool 27 such as a jig, a weight or the like, a carbon material, a glass material such as fused silica, a metal material on which an oxidation resistant film is formed, or the like is preferable. Unevenness for transferring cutting lines at the time of trailing cutting, product lot information, and the like may be formed in the jig or the weight.

Surface roughness of the binding tool 27 is not particularly limited. Arithmetic mean roughness Ra thereof is preferably 2.5 μm or smaller and arithmetic mean waviness Wa thereof is preferably 1.6 μm or smaller. The arithmetic mean roughness Ra is more preferably 1.0 μm or smaller and the arithmetic mean waviness Wa is more preferably 0.4 μm or smaller.

After the plate 1 is heated up to a forming temperature (500° C. to 800° C.) by the heater 4 so as to be softened as illustrated in (b) of FIG. 6, an air between the plate 1 and the shaping die 21 is evacuated by a vacuum device (not illustrated) through the suction passage 25, to establish a negative pressure between the plate 1 and the shaping die 21.

The softened plate 1 is gradually bent downward by the gravity and the negative pressure supplied by the vacuum device, whereby the plate member 3 which is formed with following the shaping surface 211 is obtained. The first uplift portion 31 of the plate member 3 is formed by a hole trace of an exhaust hole 2117. The first alignment mark 351 and the second alignment mark 353 are formed on the plate 1. In the forming step, the temperature of the plate 1, which is in a state of being lower than the temperature of the shaping die 21 when being placed reversely turns into a state of being higher than the temperature of the shaping die 21 when the forming is finished.

In the case where the temperature of the shaping die 21 at the time of starting the forming step is set to be higher than the temperature of the plate 1, there are an advantage in that the plate 1 can be quickly heated by radiation or heat conduction from the shaping die 21. Then, the temperature of the plate 1 becomes higher than the temperature of the shaping die 21 and the maximum temperature difference between the plate 1 and the shaping die 21 at the time of forming in this state is preferably less than 100° C. Thus, an occurrence of transfer failure of the first uplift portion 31, the alignment mark 35 or the like due to a difference in thermal expansion coefficient between the plate 1 and the shaping die 21 can be suppressed. In addition, transfer of the shaping surface 211 of the shaping die 21 to the plate member 3 can be also suppressed.

Then, as illustrated in (a) of FIG. 7, the shaped plate member 3 and the shaping die 21 are cooled up to the vicinity of 50° C. to 500° C. Then, the vacuum device is suspended. As illustrated in (b) of FIG. 7, the plate member 3 is released from the shaping die 21. A cooling step may include an annealing treatment step of maintaining the plate member 3 at an annealing temperature for a predetermined time to remove the internal stress remaining therein.

In the above-described forming step, the vacuum shaping method is described. However, other differential pressure forming methods such as a pneumatic forming method or blow forming method can be used. A desired forming method, for example, a self-weight forming method and a press forming method can also be selected in accordance with the glass shape after the forming.

The pneumatic forming method may be performed as follows. The plate 1 is installed on the shaping die 21 on which the shaping surface 211 as a female die of the plate member 3 is formed, and a clamping mold is installed on the plate 1 so as to seal the periphery of the plate 1. Then, the plate 1 is softened by heating, and pressure is applied to the top surface of the plate 1 with compressed air or the like. Differential pressure is applied to the front and back surfaces of the plate 1, thereby performing shaping. Vacuum forming and pneumatic forming may be performed in combination with each other.

The blow forming method may be performed as follows. A gob is prepared by glass raw material heated to about 1,200° C. The gob is supplied to a predetermined shaping die corresponding to the shape of the plate member 3, and a high-pressure air is supplied in the gob to expand the gob, thereby forming the shape of the plate member 3. At this time, the high-pressure air may be supplied after the gob in the die is shaped by a rod-shaped die such as a plunger. Accordingly, the plate member 3 with a desired shape can be obtained.

The self-weight forming method is a method of performing forming to have a predetermined shape in a manner that the plate 1 is installed on a predetermined mold corresponding to the shape of the plate member 3, and then, the plate 1 is softened by heating and the plate 1 is bent by gravity and allowed to fit into a mold.

The press forming method is a method of performing forming to have a predetermined shape in a manner that the plate 1 is installed between predetermined molds (lower mold and upper mold) corresponding to the shape of the plate member 3, and then a press load is applied between the upper and lower molds in a state where the plate 1 is softened, and thus the plate 1 is bent and fit to the mold.

Accordingly, in the forming methods other than the vacuum forming method, a recess (not illustrated) provided in the shaping die 21 can be used as a mark forming portion that forms the first alignment mark 351 or the second alignment mark 353.

As illustrated in FIG. 1 and FIG. 2, a plurality (9 pieces in the illustrated embodiment) of first uplift portions 31 are aligned and arranged in the plate member 3 formed by the procedure illustrated in FIG. 5 to FIG. 7.

### Removal Step

By using the above-described plate member 3, the first uplift portion 31 is removed to manufacture the processed member 5. For example, the opening member 53 having one or more opening portions 531 and the structural portion 533 as illustrated in FIG. 3 is manufactured. A removing method of the first uplift portion 31 is not particularly limited. For example, the first uplift portion 31 can be removed by polishing and grinding processing or a treatment with a chemical liquid such as acid or alkali. The removal step is preferably performed from the first main surface 3a side of the plate member 3. The removal of the other uplift portions such as the second uplift portion 39 can be performed in the same manner.

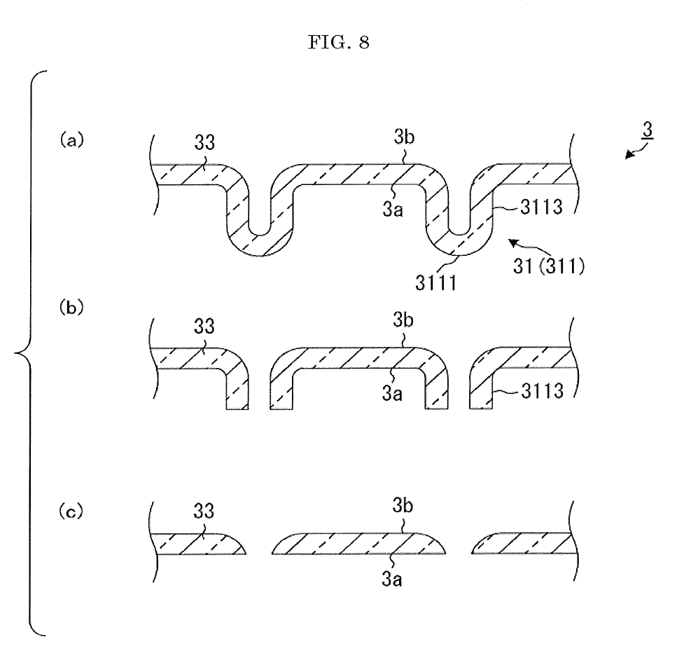

The removal step will be described with reference to FIG. 8. (a) of FIG. 8 is a sectional view of the plate member 3 and is a diagram illustrating a form in which support portions 33 are connected to each other through the first uplift portion 31. The first uplift portion 31 (protrusion portion 311) has a side surface portion 3113 and a top portion 3111. In the removal step, as illustrated in (b) of FIG. 8, the top portion 3111 may be removed to cut off the connection between the support portions 33. Alternatively, as illustrated in (c) of FIG. 8, the side surface portion 3113 may also be removed together to cut off the connection between the support portions 33.

### Polishing and Grinding

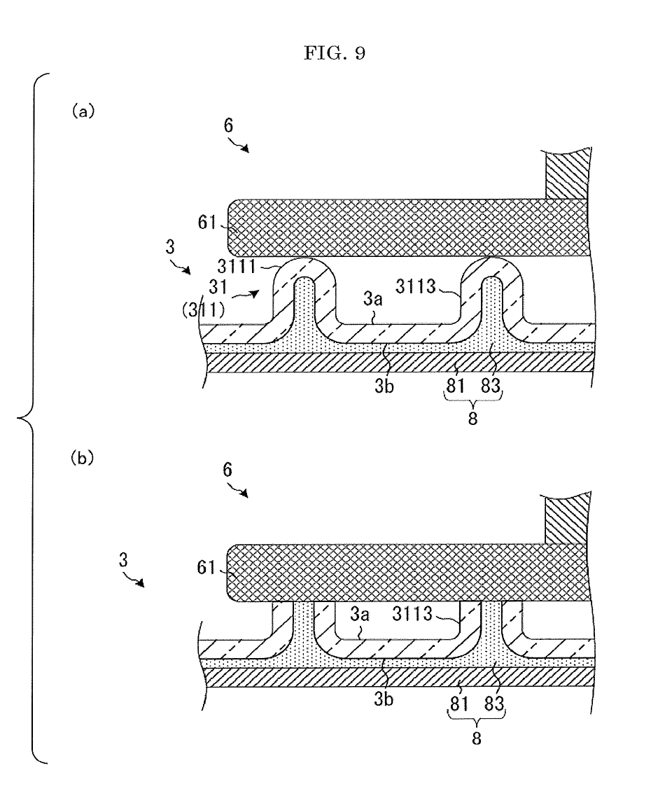

As illustrated in (a) of FIG. 9, machining such as polishing and grinding can be used for removing the first uplift portion 31. As illustrated in (b) of FIG. 9, the first uplift portion 31 is removed by a predetermined amount through rotary displacement in a state where a tool 6 such as a polishing pad or a grinding stone is brought into contact with the first uplift portion 31, by using a machining center or other numerically controlled machine tool.

In grinding, for example, grinding is performed at a spindle speed of 100 to 30,000 rpm and a cutting speed of 1 to 10,000 mm/min by using a grinding stone on which diamond abrasive grains, CBN abrasive grains, and the like are fixed by electrodeposition or metal bonding.

Polishing is performed in a manner that a polishing portion 61 of the rotary polishing tool 6 is brought into contact with the first uplift portion 31 at constant pressure and is relatively moved at a constant speed. When polishing is performed under conditions of constant pressure and the constant speed, a grinding surface can be uniformly polished at a constant polishing rate. Pressure of the polishing portion of the rotary polishing tool at a time of contact is preferably 1 to 1,000,000 Pa from a viewpoint of economy and easy control. The speed is preferably 1 to 10,000 mm/min from a viewpoint of, for example, economy and easy control. The moving amount can be appropriately determined in accordance with the shape and the size of the plate member 3. The rotary polishing tool is not particularly limited so long as the polishing portion is a rotatable body which can perform polishing. A spindle having a tool chucking portion, a system of attaching a polishing tool to a Leutor, and the like are exemplified. The material of the rotary polishing tool is not particularly limited so long as at least the polishing portion, such as a cerium pad, a rubber grinding stone, felt buff, and polyurethane, can process and remove a workpiece and has a Young's modulus of preferably 7 GPa or smaller and more preferably 5 GPa or smaller. If a member having a Young's modulus of 7 GPa or smaller is used as the material of the rotary polishing tool, the removal surface of the first uplift portion 31 can be processed to have desired surface roughness. As the shape of the polishing portion of the rotary polishing tool, a circle or donut-like flat board, a cylindrical shape, a shell shape, a disk shape, a barrel shape, and the like can be exemplified.

In the case where the polishing portion of the rotary polishing tool is brought into contact with the first uplift portion 31 to perform polishing, processing is preferably performed in a state of interposing an abrasive grain slurry. In this case, as the abrasive grain, silica, ceria, Alundum (registered trademark), White Alundum (WA, registered trademark), emery, zirconia, SiC, diamond, titania, germania, and the like can be exemplified. The particle size thereof is preferably 10 nm to 10 μm. The relative moving speed of the rotary polishing tool can be selected within a range of 1 to 10,000 mm/min, as described above. The number of rotations of the polishing portion of the rotary polishing tool may be 100 to 10,000 rpm. If the number of rotations is small, the processing rate is slow, and it takes too much time to obtain desired surface roughness in some cases. If the number of rotations is large, the processing rate is fast, and the wear of the tool becomes severe. Thus, control of polishing may be difficult.

Polishing may be performed by relatively moving the rotary polishing tool and the plate member 3. Any method of moving the rotary polishing tool and the plate member may be employed so long as the moving amount, direction and speed can be controlled to be constant. For example, a method using a multi-axis robot, or the like is exemplified.

Treatment with Chemical Liquid

The first uplift portion 31 can be removed by using a treatment with a chemical liquid such as acid or alkali. In this case, the first uplift portion 31 can be brought into contact with a chemical liquid, and thus the first uplift portion 31 can be removed by a predetermined amount.

A solution containing hydrofluoric acid as a main component can be used as the acid. A solution containing sodium hydroxide or the like as a main component can be used as the alkali.

### Others

The first uplift portion 31 can be removed by dry etching with a fluorine-based gas and the like. Since the thickness t′ of the first uplift portion 31 is thin, the first uplift portion 31 can be broken by applying an external force. In this case, since the fracture surface caused by the breakage is irregular, chamfering or the like is preferably performed. It is not particularly limited so long as the first uplift portion 31 is treated. The first uplift portion can be cut by laser, cutter or the like, and heat-shock can be also utilized.

FIG. 10 illustrates thickness-direction sectional views of the plate member 3 in which the first uplift portion 31 has the base portion 313, and includes diagrams illustrating a form in which the protrusion portion 311 is removed. With the removal step, only the top portion 3111 may be removed to obtain the sectional-view shape as illustrated in (b) of FIG. 10. Alternatively, the side surface portion 3113 may be further removed to obtain the sectional-view shape as illustrated in (c) of FIG. 10.

As illustrated in FIG. 11, regarding the plate member 3 in which the side surface portion 3133 of the base portion 313 is set to be inclined in the thickness-direction sectional view, the top portion 3111 and the side surface portion 3113 may be removed by the removal step, and thus the sectional-view shape as illustrated in (b) of FIG. 11 may be obtained.

### Fixing Step

Before the removal step, a step of fixing the plate member 3 to the fixing member 8 may be performed. Thus, in the removal step of the first uplift portion 31 when the processed member 5 is manufactured from the plate member 3, damage can be more reduced and productivity can be improved. The fixing member 8 is not particularly limited. Fixing may be performed by a sucker or the like. As illustrated in FIG. 9, the plate member 3 is preferably fixed to a fixing base 81 having high rigidity through a paste 83. Accordingly, the paste 83 can be treated along the complicated shape of the plate member 3 and the plate member 3 can be reliably fixed to the fixing pedestal 81. In the case where the first uplift portion 31 is removed from the first main surface 3a, the second main surface 3b side is preferably fixed to the fixing member 8.

The material of the fixing base 81 is not particularly limited so long as the material has rigidity. For example, metal, glass, ceramics, plastic, and rubber can be used. A material which can accurately hold the processed surface of the plate member 3 is preferably used.

The paste 83 can be removed after the removal step of the first uplift portion 31. The paste 83 preferably has a property of being easily removed by washing, melting, or the like. For example, a wax, an adhesive or the like can be used.

### Other Steps

In addition, the plate 1, the plate member 3 or the processed member 5 can be appropriately subjected to, if necessary, washing, polishing, printing, a surface treatment, and the like. In particular, the plate member 3 after forming or the processed member 5 is preferably subjected to an annealing treatment.

### Annealing Step

Annealing treatment is a treatment for removing a residual strain or residual stress from the plate member 3 after forming or the processed member 5. In the case where a desired shape is imparted during the forming step when manufacturing the plate member 3 or the processed member 5, a large residual stress may generate in the formed member in some cases. The plate member 3 or processed member 5 containing the residual stress may cause inconvenience such that only uneven reinforcement treatment is achieved in the chemical reinforcement step, which will be described later.

In particular, the plate member 3 or processed member 5 having a complicated shape easily cracks due to the residual strain and easily bends due to the residual stress in the chemical reinforcement treatment. Therefore, for these member, an annealing treatment is particularly effective. In addition, since the plate member 3 or the processed member 5 may be used in an electronic device, an optical distortion due to the residual stress should be reduced as possible. Therefore, an annealing treatment that can remove the residual stress is useful.

In the annealing treatment, the plate member 3 or the processed member 5 is heated up to a predetermined temperature (annealing temperature), retained (held) at a predetermined temperature after heating, and then, gradually cooled (annealed).

In the heating phase, the plate member 3 or the processed member 5 is preferably heated such that the equilibrated viscosity thereof be from 10^{12.5} to 10¹⁷ Pa·s. The predetermined annealing temperature in the annealing step is, for example, preferably about 550° C.

In the temperature retaining phase, the plate member 3 or processed member 5 heated to the annealing temperature is preferably held at this temperature for, for example, 10 to 60 minutes. Accordingly, the member can be cooled to a room temperature while suppressing creep deformation. If necessary, the plate member 3 or processed member 5 may be retained at a temperature set lower than the heating temperature in the heating phase. Here, the “creep deformation” is a phenomenon that the glass shape deforms with time when, for example, the glass is heated such that the equilibrated viscosity thereof be from 10¹²⁵ to 10¹⁷ Pa·s and retained.

In the gradually cooling phase, the cooling rate of the plate member 3 or processed member 5 is preferably, for example, 0.3 to 10° C./min, and more preferably 0.3 to 5° C./min. Accordingly, a temperature distribution is less likely to be generated in these glass member and thus, the occurrence of the residual stress due to the temperature distribution can be suppressed. The end point of the gradually cooling is, for example, up to a state at which the temperature of the glass member reaches room temperature, or at which the equilibrated viscosity thereof reaches 10^{17.8} Pa·s or higher.

The annealing step only have to be performed after the forming step. The annealing step may be performed just after the completion of the forming step, or may be performed after the completion of the removal step performed after the forming step. The annealing step is preferably performed before the chemical reinforcement step, which will be described later. This is because if the annealing step is performed after the chemical reinforcement step, the compressive stress layer formed on the plate member 5 or processed member 5 in the chemical reinforcement step may be relieved, and it may be difficult to attain a desired strength.

### EXAMPLES

### Example 1

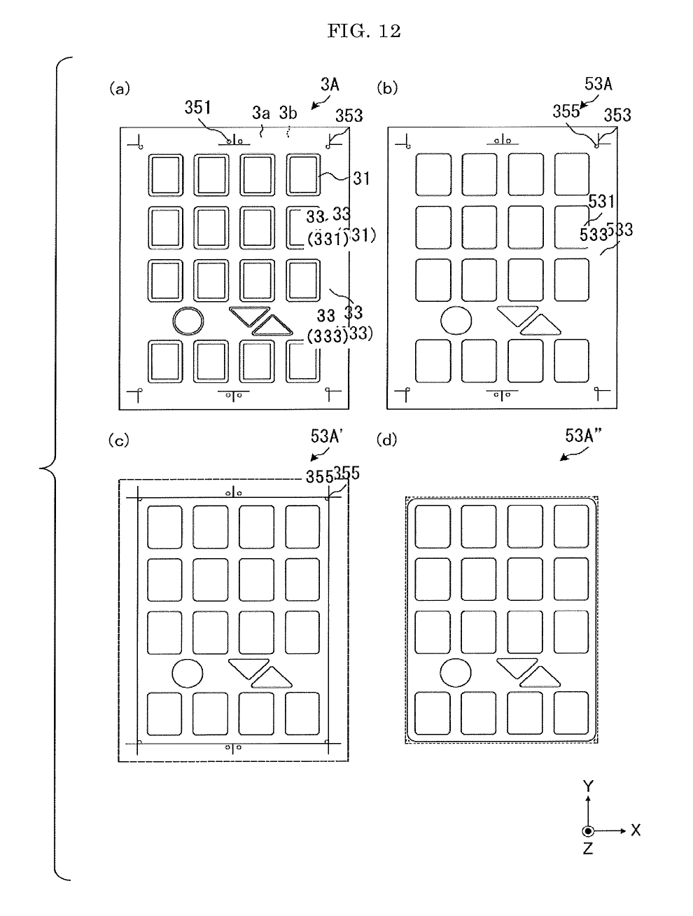

The procedure of manufacturing the processed member 5 from the plate member 3 will be described with reference to FIG. 12. A glass plate 1 in which the length in the X-direction was 300 mm, the length in the Y-direction was 400 mm, and the thickness in the Z-direction was 0.7 mm was prepared. Heating and shaping were performed on the glass plate 1, and thus total 19 endless first uplift portions 31 having, for example, a substantially rectangular shape were formed so as to protrude on the first main surface 3a side, to thereby prepare a plate member 3A as illustrated in (a) of FIG. 12.

Then, the first uplift portion 31 of the plate member 3A in (a) of FIG. 12 was removed by being ground from the first main surface 3a side. Thus, the removal portion 331 of the support portion 33, which was surrounded by the first uplift portions 31, was removed, thereby obtaining an opening member 53A as illustrated in (b) of FIG. 12.

Subsequently, the outer edge of the opening member 53A was roughly cut. In the rough cutting, positioning of the opening member 53A was performed by referring to the first alignment marks 351, and an imaginary line obtained by connecting the second alignment marks 353 was cut with a wheel cutter, thereby obtaining an opening member 53A′ as illustrated in (c) of FIG. 12.

Finally, chamfering was performed such that the end surface of the opening member 53A′ has a desired shape. First, the opening member 53A′ was placed in a machining center. Four third alignment marks 355 on the corner portions of the opening member 53A′ were grasped by a camera, and then positioning was performed. Then, the end surface of the opening member 53A′ was processed with a grinding stone and the third alignment marks 355 were also removed. Accordingly, an opening member 53A″ having rounded corners was obtained.

### Example 2

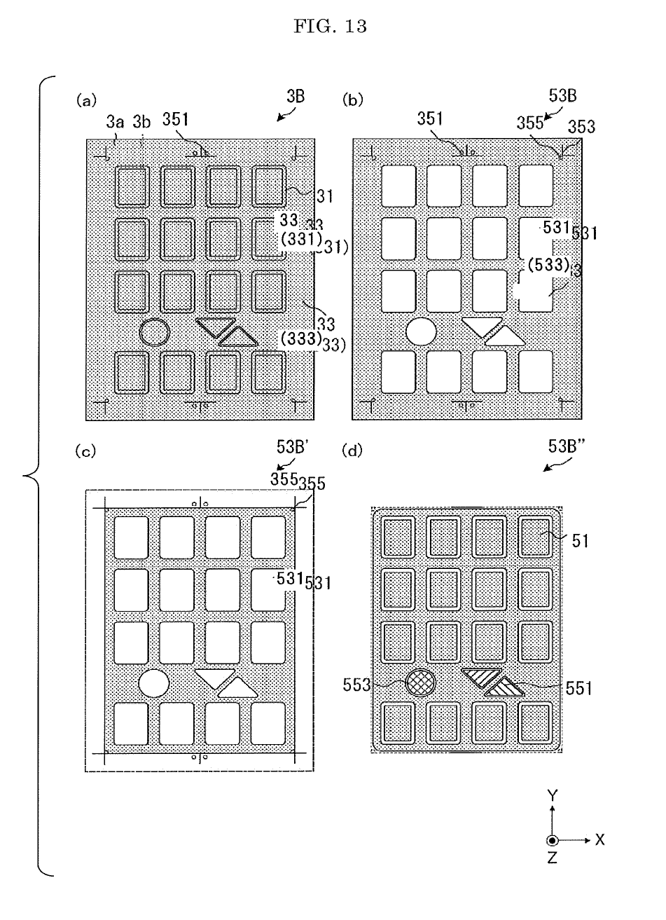

A black printing layer was formed on the second main surface 3b of the plate member 3A obtained in Example 1, thereby obtaining a plate member 3B as illustrated in (a) of FIG. 13. With respect to the plate member 3B, in the same manner as in Example 1, the first uplift portion 31 was removed, thereby obtaining an opening member 53B as illustrated in (b) of FIG. 13. Then, the outer edge was roughly cut, thereby obtaining an opening member 53B′ as illustrated in (c) of FIG. 13.

The obtained opening member 53B′ was placed in a machining center. Four third alignment marks 355 on the corner portions of the opening member 53B′ were grasped by a camera, and then positioning was performed. The end surface of the opening member 53B′ was processed with a grinding stone, thereby obtaining an opening member 53B″ having rounded corners. Regarding the removal portion 331 removed when the opening member 53B was manufactured, chamfering was performed on the end surface, thereby obtaining a small plate piece 51.

The obtained opening member 53B″ can be used as a top plate of a keyboard, for example. In this case, the small plate piece 51 can be used as some of character buttons. Characters and the like may have been printed on the printing layer corresponding to the small plate piece 51 in advance. A glass member 551 separately obtained by being processed in another step may be fit with the opening portion 531. A different material member 553 of metal or the like may be attached to the opening 531. Accordingly, a member having an external appearance as illustrated in (d) of FIG. 13 can be obtained.

### Example 3

The shape of the shaping surface 211 of the shaping die 21 to be used was changed without changing forming conditions in Example 1. Thus, a plate member 3C including a first uplift portion 31 (protrusion portion 311) and a second uplift portion 39 was obtained. The first uplift portion 31 includes the base portion 313 protruding toward the first main surface 3a side. The second uplift portion 39 protrudes toward the second main surface 3b side. The procedure of manufacturing an opening member 53C by using the plate member 3C will be described with reference to top views of FIG. 14 and sectional views of FIG. 15.

First, the second uplift portion 39 of the plate member 3C as illustrated in (a) of FIG. 14 and (a) of FIG. 15 was removed from the second main surface 3b side by grinding. Thus, a portion of the plate member 3C on the outside of an area surrounded by the second uplift portions 39 can be removed, thereby obtaining a member 3C′ as illustrated in (b) of FIG. 14 and (b) of FIG. 15.

Then, the protrusion portion 311 of the first uplift portion 31 in the member 3C′ as illustrated in (b) of FIG. 14 and (b) of FIG. 15 was removed from the first main surface 3a side by grinding. Thus, the removal portion 331 of the support portion 33, which was surrounded by the protrusion portions 311 was removed, thereby obtaining an opening member 53C as illustrated in (c) of FIG. 14 and (c) of FIG. 15.

### Example 4

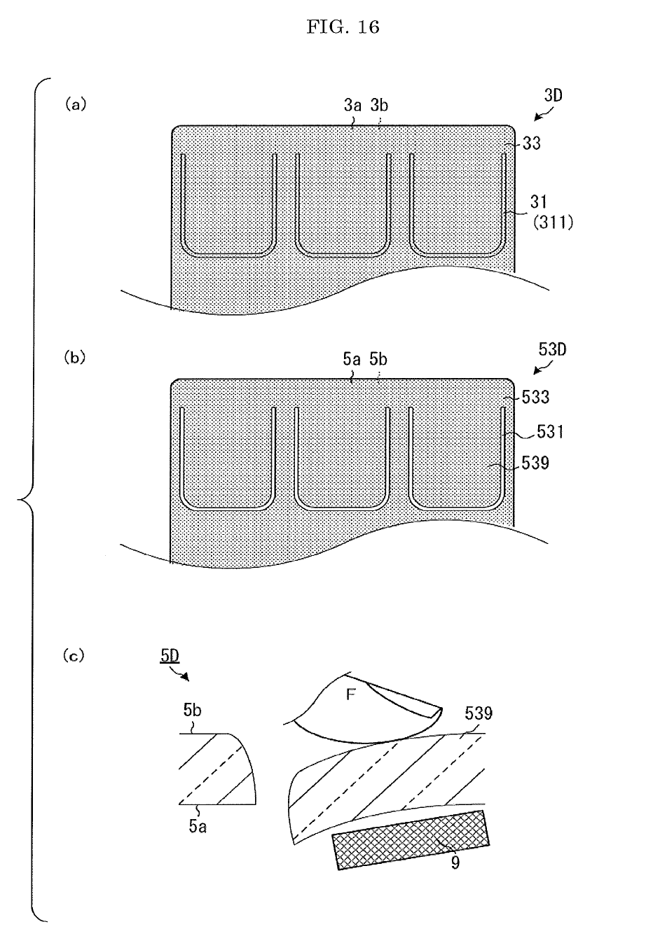

The shape of the shaping surface 211 of the shaping die 21 to be used was changed without changing forming conditions in Example 1. Thus, a plate member 3D in which a U-shaped first uplift portion 31 which was not endless in a top view was formed was obtained as illustrated in (a) of FIG. 16. When the first uplift portion 31 was removed by grinding or the like, an opening member 53D in which only a portion corresponding to the first uplift portion 31 was opened, as illustrated in (b) of FIG. 16, was obtained. The opening member 53D includes a movable portion 539 connected to the structural portion 533.

For example, as illustrated in (c) of FIG. 16, an electronic device in which the opening member 53D (processed member 5D) is placed on an electronic member 9 such as a sensor in a state where the second main surface 5b is directed to the outside can be obtained. When a user touches the second main surface 5b of the movable portion 539 and presses the movable portion 539 with the finger F, the finger F approaches the sensor 9 and the sensor performs the function.

### Example 5

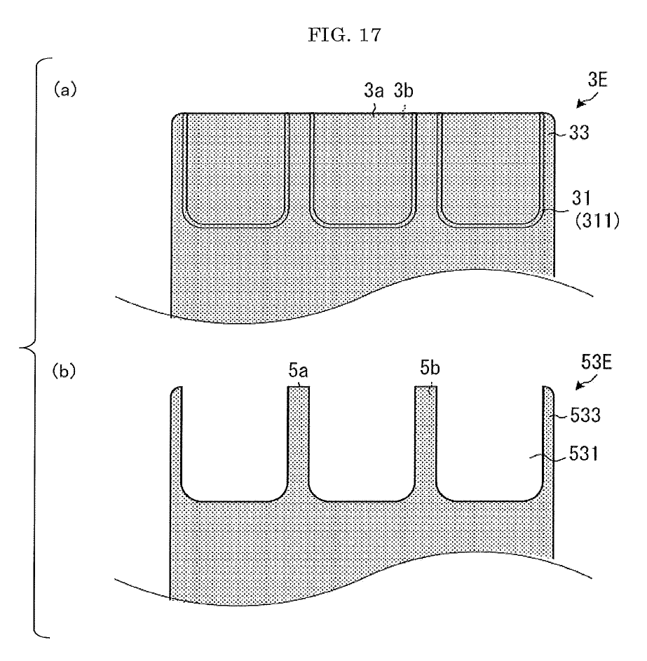

The shape of the shaping surface 211 of the shaping die 21 to be used was changed without changing forming conditions in Example 1. Thus, a plate member 3E in which a U-shaped first uplift portion 31 which was not endless in a top view was formed was obtained as illustrated in (a) of FIG. 17. When the first uplift portion 31 was removed by grinding or the like, an opening member 53E in which a portion corresponding to the first uplift portion 31 and the support portion 33 surrounded thereby were opened, as illustrated in (b) of FIG. 17, was obtained.

### Modification Example

As a glass composition of the plate 1, the plate member 3, and the processed member 5 in this embodiment, for example, soda lime glass, aluminosilicate glass, aluminoborosilicate glass, lithium silicate glass and the like can be used.

### Composition

Specific examples of the glass composition include glass having a composition containing, in terms of mol % on the basis of oxides, 50% to 80% of SiO₂, 0.1% to 25% of Al₂O₃, 3% to 30% of Li₂O+Na₂O+K₂O, 0% to 25% of MgO, 0% to 25% of CaO, and 0% to 5% of ZrO₂. However, it is not particularly limited thereto. More specifically, the following compositions of glass are exemplified. For example, “containing 0% to 25% of MgO” means that MgO is not essential but may be contained up to 25%.

(i) Glass having a composition containing, in terms of mol % on the basis of oxides, 63% to 73% of SiO₂, 0.1% to 5.2% of Al₂O₃, 10% to 16% of Na₂O, 0% to 1.5% of K₂O, 0% to 5% of Li₂O, 5% to 13% of MgO, and 4% to 10% of CaO.
(ii) Glass having a composition containing, in terms of mol % on the basis of oxides, 50% to 74% of SiO₂, 1% to 10% of Al₂O₃, 6% to 14% of Na₂O, 3% to 11% of K₂O, 0% to 5% of Li₂O, 2% to 15% of MgO, 0% to 6% of CaO, and 0% to 5% of ZrO₂, in which the sum content of SiO₂ and Al₂O₃ is 75% or smaller, the sum content of Na₂O and K₂O is 12% to 25%, and the sum content of MgO and CaO is 7% to 15%.
(iii) Glass having a composition containing, in terms of mol % on the basis of oxides, 68% to 80% of SiO₂, 4% to 10% of Al₂O₃, 5% to 15% of Na₂O, 0% to 1% of K₂O, 0% to 5% of Li₂O, 4% to 15% of MgO, and 0% to 1% of ZrO₂.
(iv) Glass having a composition containing, in terms of mol % on the basis of oxides, 67% to 75% of SiO₂, 0% to 4% of Al₂O₃, 7% to 15% of Na₂O, 1% to 9% of K₂O, 0% to 5% of Li₂O, 6% to 14% of MgO, and 0% to 1.5% of ZrO₂, in which the sum content of SiO₂ and Al₂O₃ is 71% to 75%, the sum content of Na₂O and K₂O is 12% to 20%, and the content of CaO in a case of containing CaO is smaller than 1%.
(v) Glass having a composition containing, in terms of mol % on the basis of oxides, 50% to 80% of SiO₂, 2% to 25% of Al₂O₃, 0% to 10% of Li₂O, 0% to 18% of Na₂O, 0% to 10% of K₂O, 0% to 15% of MgO, 0% to 5% of CaO, and 0% to 5% of ZrO₂.
(vi) Glass having a composition containing, in terms of mol % on the basis of oxides, 50% to 74% of SiO₂, 1% to 10% of Al₂O₃, 6% to 14% of Na₂O, 3% to 11% of K₂O, 2% to 15% of MgO, 0% to 6% of CaO, and 0% to 5% of ZrO₂, in which the sum content of SiO₂ and Al₂O₃ is 75% or smaller, the sum content of Na₂O and K₂O is 12% to 25%, and the sum content of MgO and CaO is 7% to 15%.
(vii) Glass having a composition containing, in terms of mol % on the basis of oxides, 68% to 80% of SiO₂, 4% to 10% of Al₂O₃, 5% to 15% of Na₂O, 0% to 1% of K₂O, 4% to 15% of MgO, and 0% to 1% of ZrO₂, in which the sum content of SiO₂ and Al₂O₃ is 80% or smaller.
(viii) Glass having a composition containing, in terms of mol % on the basis of oxides, 67% to 75% of SiO₂, 0% to 4% of Al₂O₃, 7% to 15% of Na₂O, 1% to 9% of K₂O, 6% to 14% of MgO, 0% to 1% of CaO, and 0% to 1.5% of ZrO₂, in which the sum content of SiO₂ and Al₂O₃ is 71% to 75% and the sum content of Na₂O and K₂O is 12% to 20%.
(ix) Glass having a composition containing, in terms of mol % on the basis of oxides, 60% to 75% of SiO₂, 0.5% to 8% of Al₂O₃, 10% to 18% of Na₂O, 0% to 5% of K₂O, 6% to 15% of MgO, and 0% to 8% of CaO.
(x) Glass having a composition containing, in terms of mol % on the basis of oxides, 63% to 75% of SiO₂, 3% to 12% of Al₂O₃, 3% to 10% of MgO, 0.5% to 10% of CaO, 0% to 3% of SrO, 0% to 3% of BaO, 10% to 18% of Na₂O, 0% to 8% of K₂O, 0% to 3% of ZrO₂, and 0.005% to 0.25% of Fe₂O₃, in which R₂O/Al₂O₃ (R₂O is Na₂O+K₂O) is 2.0 or lager and 4.6 or smaller.
(xi) Glass having a composition containing, in terms of mol % on the basis of oxides, 66% to 75% of SiO₂, 0% to 3% of Al₂O₃, 1% to 9% of MgO, 1% to 12% of CaO, 10% to 16% of Na₂O, and 0% to 5% of K₂O.

In the case where glass is colored and used, a colorant may be added in a range without hindering achievement of desired chemical reinforcement properties. For example, Co₃O₄, MnO, MnO₂, Fe₂O₃, NiO, CuO, Cu₂O, Cr₂O₃, V₂O₅, Bi₂O₃, SeO₂, TiO₂, CeO₂, Er₂O₃, and Nd₂O₃ which absorb light in a visible range and are metal oxides of Co, Mn, Fe, Ni, Cu, Cr, V, Bi, Se, Ti, Ce, Er, and Nd are exemplified.

In the case where colored glass is used as a glass base, a coloring component (at least one component selected from the group consisting of metal oxides of Co, Mn, Fe, Ni, Cu, Cr, V, Bi, Se, Ti, Ce, Er, and Nd) in a range of 7% or smaller may be contained in glass, in terms of mol % on the basis of oxides. If the coloring component is greater than 7%, the glass is easily devitrified. The content thereof is preferably 5% or smaller, more preferably 3% or smaller, and further preferably 1% or smaller. The glass base may appropriately contain S03, a chloride, a fluoride, and the like as a fining agent in melting.

The present invention is not limited to the above-described embodiment, and modification, improvement and the like may be appropriately made. Steps or processing as follows may be performed on the plate 1, plate member 3 and processed member 5 (collectively referred to as “members” below).

### Grinding and Polishing Step

Grinding or polishing may be performed on at least one main surface of the members. In particular, if polishing or grinding is performed in order to remove the unevenness of the glass surface onto which the unevenness of the mold has been transferred in heating and shaping, a desired flat surface can be obtained.

### End Surface Processing Step

The circumferential portion or the end surface of the members may be subjected to processing such as chamfering. Generally, processing referred to as R chamfering or C chamfering is preferably performed by mechanical grinding. However, processing such as etching may be performed. It is not particularly limited. The forming step may be performed after end surface processing is previously performed on a glass base having a flat-plate shape.

### Chemical Reinforcement Step

In the case where the members are glass, a compressive stress layer can be formed on the surface by chemical reinforcement, and thus strength and abrasion resistance can be improved. The chemical reinforcement is a treatment of forming a compressive stress layer on a glass surface in a manner that an alkali metal ion (typically Na ion) having a smaller ionic radius on the glass surface is replaced with another alkali metal ion (typically K ion) having a larger ionic radius at a temperature of a glass transition point or lower by ion exchange. The chemical reinforcement treatment can be performed by the well-known conventional method. Generally, glass is immersed in a potassium nitrate molten salt. The number of times of immersing is one time or greater. Immersing may be performed two times or greater under a condition of a different molten salt. About 10% by mass of potassium carbonate may be mixed with the molten salt and the resultant may be used. Thus, glass having high strength in which cracks and the like on the surface layer of the glass is removed can be obtained. When a silver component such as a silver nitrate is mixed to the potassium nitrate at the time of chemical reinforcement, glass is subjected to ion exchange to have a silver ion on the surface thereof, and antibacterial properties can be imparted.

After the plate member 3 is chemically reinforced, the processed member 5 may be manufactured. Alternatively, chemical reinforcement may be performed after the processed member 5 is manufactured from the plate member 3. With the latter, the processed member 5 is chemically reinforced up to the end surface and a formed body having high strength can be obtained.

The plate member 3 or processed member 5 is preferably chemically reinforced through the chemical reinforcement step after completion of the annealing treatment through the annealing step described above. The residual strain and residual stress on the formed plate member 3 or processed member 5 can be removed by the annealing treatment. In the case where a desired shape is imparted during the forming step when manufacturing the plate member 3 or processed member 5, a large residual stress may generate in the formed member in some cases. The plate member 3 or processed member 5 containing the residual stress may cause inconvenience such that only uneven reinforcement treatment is achieved in the chemical reinforcement step.

In particular, the plate member 3 or processed member 5 having a complicated shape easily cracks due to the residual strain and easily bends due to the residual stress in the chemical reinforcement treatment. Therefore, for these member, an annealing treatment is particularly effective. In addition, since the plate member 3 or the processed member 5 may be used in an electronic device, an optical distortion due to the residual stress should be reduced as possible. Therefore, an annealing treatment that can remove the residual stress is useful.

When the annealing treatment is performed, the residual stress in the plate member 3 or processed member 5 is lowered. The residual stress can be evaluated by an index of “principal stress difference Σ”. The principal stress difference Σ of the plate member 3 or processed member 5 is preferably 7 MPa or smaller, more preferably 5 MPa or smaller, and further preferably 3 MPa or smaller, in terms of value of integral at an arbitrary point in the surface. Accordingly, the plate member 3 and the processed member 5, in which cracking hardly occurs due to the reduced residual strain and bending is suppressed due to the reduced residual stress, and which has a reduced optical distortion, can be obtained. The lower limit value of the principal stress difference Σ is not limited.

The “principal stress difference Σ” can be measured as follows. At an arbitrary point in a main surface of a measurement target such as glass, a phase difference φ is measured, and the phase difference φ is divided by the photoelastic constant E of the measurement target, to thereby obtain the principal stress difference Σ. The principal stress difference Σ indicates the absolute value of a difference between the value (∫σₘₐₓdt) of integral of maximum principal stress σₘₐₓ of the measurement target at the measured point with respect to the thickness t direction and the value (∫σₘᵢₙdt) of integral of minimum principal stress σₘᵢₙ. The principal stress difference Σ implies a stress distribution at the arbitrary point. The phase difference φ can be measured by, for example, a wide-range birefringence analyzer (model number of WPA-100) manufactured by Photonic Lattice, Inc., and the principal stress difference Σ can be calculated by an accompanying software (WPA-view).

### Printing Step

For a printing step, for example, spray printing, ink jet printing, and screen printing can be used. With these methods, printing can be favorably performed even in the case of a glass base having a wide area. In particular, in the spray printing, printing can be easily performed on a glass base and the like having a curved portion, and surface roughness on a printing surface can be easily adjusted. In the screen printing, a desired printing pattern can be easily formed on a glass base and the like having a wide flat portion so as to have a uniform average thickness. A plurality of inks may be used. From a viewpoint of adhesiveness of the printing layer, a uniform ink is preferably used.

The processed member 5 may be produced by removing the first uplift portion 31 after pre-printing is performed on the plate member 3. Accordingly, a uniform printing layer can be obtained with high accuracy. After the processed member 5 is manufactured, printing may be performed.

The ink for forming the printing layer may be inorganic or organic. As the inorganic ink, for example, any of at least one kind selected from SiO₂, ZnO, B₂O₃, Bi₂O₃, Li₂O, Na₂O, and K₂O, at least one kind selected from CuO, Al₂O₃, ZrO₂, SnO₂, and CeO₂, and a composite made from Fe₂O₃ and TiO₂ may be used.

As the organic ink, various printing materials in which a resin is dissolved in a solvent can be used. For example, as the resin, at least one kind selected from the group consisting of resins such as acrylic resins, urethane resins, epoxy resins, polyester resins, polyamide resins, vinyl acetate resins, phenol resins, olefins, ethylene-vinyl acetate copolymer resins, polyvinyl acetal resins, natural rubber, styrene-butadiene copolymers, acrylonitrile-butadiene copolymers, polyester polyols, and polyether polyurethane polyols may be used. As the solvent, water, alcohols, esters, ketones, aromatic hydrocarbon solvents, and aliphatic hydrocarbon solvents may be used. For example, isopropyl alcohol, methanol, and ethanol can be used as the alcohols. Ethyl acetate can be used as the esters. Methyl ethyl ketone can be used as the ketones. As the aromatic hydrocarbon solvents, toluene, xylene, SOLVESSO 100 or SOLVESSO 150 (manufactured by Exxon Mobil Corporation), and the like can be used. Hexane and the like can be used as the aliphatic hydrocarbon solvents. The above solvents are just examples. In addition, various printing materials can be used. After the members are coated with the organic printing material, the solvent can be evaporated to form a resin layer, thereby obtaining a printing layer.

The ink used in the printing layer may contain a colorant. As the colorant, for example, in the case where the printing layer is set to be black, a black colorant such as carbon black can be used. In addition, a colorant of an appropriate color for a desired color can be used. The printing layer may be a light shielding layer for the purpose of screening, may be an infrared transmitting layer that can transmit only infrared light, or may be a semi-transmitting layer that can shield a visible light to an extent. There is no particular limitation.

### Surface Treatment Step

If necessary, a step of forming various surface-treated layers may be performed on the members. Examples of the surface-treated layer include an antiglare treatment layer, an antireflection treatment layer, an antifouling treatment layer, and an antibacterial treatment layer. The layers may be used in combination. The surface treatment may be performed on any of the first main surface and the second main surface of the members. The surface-treated layer is preferably formed after the forming step. However, the antiglare treatment layer may be formed before the forming step and may be formed simultaneously with the forming step. Forming may be performed after the antiglare treatment layer is formed by, for example, etching on a glass base having a flat-plate shape.

### Antiglare Treatment Layer

The antiglare treatment layer is a layer which has a main effect of scattering reflected light and reducing the glare of the reflected light by reflection from a light source. In the case where the opening member or small plate piece is used in an electronic device, symbols or the like provided on the opening member or small plate piece is sometimes difficult to be recognized due to the light source from a monitor screen. This inconvenience can be solved by forming the antiglare treatment layer. In the case where a display panel is provided in the opening member or small plate piece, visibility is sometimes deteriorated due to the reflection of the outside light when the display is viewed through the opening member or small plate piece. This inconvenience can be also solved by forming the antiglare treatment layer. The antiglare treatment layer may be formed by processing the surface of the members or may be formed by separately performing deposition. As a forming method of the antiglare treatment layer, for example, a method of forming an uneven shape having desired surface roughness in a manner that a surface treatment is performed on at least a portion of the members by a chemical (e.g., etching) or physical (e.g., sandblasting) method, can be used. As a forming method, an uneven structure may be formed on a plate by applying or spraying a treatment liquid onto at least a portion of the members. The application method and spraying method are not particularly limited, and a spraying method and a static coating method are preferable. In addition, an uneven structure may be formed in at least a portion of the members by a thermal method.

Regarding the antiglare treatment layer, root mean square roughness Rq is preferably 0.3 nm to 10 μm from a viewpoint of roughness and a finger slip property; maximum height roughness Rz is preferably 0.5 nm to 10 μm from a viewpoint of the roughness and the finger slip property; maximum section height roughness Rt is preferably 0.5 nm to 5 μm from the roughness and the finger slip property; maximum peak height roughness Rp is preferably 0.3 nm to 5 μm from a viewpoint of the roughness and the finger slip property; and maximum valley depth roughness Rv is preferably 0.3 nm to 5 μm from a viewpoint of the roughness and the finger slip property. Average length roughness Rsm is preferably 0.3 nm to 10 μm from a viewpoint of the roughness and the finger slip property. Kurtzys roughness Rku is preferably 1 to 30 from a viewpoint of the tactile sensation.

Skewness roughness Rsk of the antiglare treatment layer is preferably −1 or more and 1.3 or less from a viewpoint of visibility, uniformity of the tactile sensation and the like. In the case where the Skewness roughness Rsk is the upper limit value or less, excellent antiglare properties and tactile sensation can be maintained and also haze can be lowered. Furthermore, in the case where the antiglare treatment layer is to be touched by a user, the Skewness roughness Rsk of the antiglare treatment layer is more preferably −1 or more and 1 or less. This is because in the case where the Skewness roughness Rsk is 1 or less, fingerprint, if attached can be easily removed.

### Antireflection Treatment Layer

The antireflection treatment layer is a layer which has effects of reducing the reflectance and reducing glare by reflection of light, and a layer in which the transmittance of light from a display device can be improved and visibility of the display device can be improved in the case where a member is used in the display device.

In the case where the antireflection treatment layer is an antireflection film, the film is preferably formed on the first main surface or the second main surface of the members. However, it is not limited. The configuration of the antireflection film is not limited so long as the antireflection film can suppress the reflection of light. For example, a configuration in which a high refractive index layer having a refractive index of 1.9 or greater at a wavelength of 550 nm and a low refractive index layer having a refractive index of 1.6 or smaller at a wavelength of 550 nm are stacked, or a configuration of including a layer in which hollow particles or pores are mixed in a film matrix and a refractive index at a wavelength of 550 nm is 1.2 to 1.4 can be utilized.

### Antifouling Treatment Layer

The antifouling treatment layer is a layer which suppresses adhesion of an organic substance or an inorganic substance to the surface, or a layer having an effect in which adhered substances can be easily removed by cleaning such as wiping, even in the case where an organic substance or an inorganic substance is adhered to the surface.

In the case where the antifouling treatment layer is formed as an antifouling film, the film is preferably formed on the first main surface or the second main surface of the members or formed on other surface-treated layers. The antifouling treatment layer is not limited so long as the layer can impart antifouling properties to the obtained members. Among layers, a film formed with a fluorine-containing organosilicon compound film obtained by performing a hydrolytic condensation reaction on a fluorine-containing organosilicon compound is preferable.

After the surface-treated layer is previously formed on the plate member 3, the processed member 5 may be manufactured. Accordingly, a uniform surface-treated layer can be efficiently formed. Alternatively, after the processed member 5 is manufactured from the plate member 3, the surface-treated layer may be formed. Accordingly, the design of the surface-treated layer may be easy and the opening member 53 having desired optical characteristics can be obtained.

### Product

The usages of the plate member 3 and the processed member 5 in the present invention are not particularly limited. Specific examples thereof include automotive components (headlight cover, side mirror, front transparent substrate, side transparent substrate, rear transparent substrate, instrument panel surface, automotive display front plate, etc.), a meter, a building window, a show window, a building interior member, a building exterior member, a cover glass (portable phone, smart phone, laptop personal computer, monitor, LCD, PDP, ELD, CRT, PDA, etc.), an LCD color filter, a substrate for a touch panel, a pickup lens, a cover substrate for a CCD, a transparent substrate for a solar cell (cover glass, etc.), an electronic device housing (mouse, keyboard, etc.), an organic EL light-emitting element component, an inorganic EL light-emitting element component, a phosphor light-emitting element component, an optical filter, a lighting lamp, a cover of lighting equipment, an antireflection film, and a polarizing film.

The present invention has been described in detail with reference to specific embodiments thereof, but it will be apparent to one skilled in the art that various changes and modifications can be made without departing from the spirit and scope of the present invention.

The present application is based on Japanese Patent Application No. 2017-074753 filed on Apr. 4, 2017, the contents of which are incorporated herein by reference.

### DESCRIPTION OF REFERENCE NUMERALS AND SIGNS

1 PLATE
1a FIRST MAIN SURFACE
1b SECOND MAIN SURFACE
21 SHAPING DIE
211 SHAPING SURFACE
2111 BOTTOM SURFACE
2113 SIDE SURFACE
2115 TOP SURFACE
2117 EXHAUST HOLE
23 BASE
25 SUCTION PASSAGE
27 BINDING TOOL
3 PLATE MEMBER
3a FIRST MAIN SURFACE
3b SECOND MAIN SURFACE
31 FIRST UPLIFT PORTION
311 PROTRUSION PORTION
3111 TOP PORTION
3113 SIDE SURFACE PORTION
313 BASE PORTION
3131 FLAT PORTION
3133 SIDE SURFACE PORTION
33 SUPPORT PORTION
331 REMOVAL PORTION
333 STRUCTURAL PORTION
35 ALIGNMENT MARK
351 FIRST ALIGNMENT MARK
353 SECOND ALIGNMENT MARK
4 HEATER
5 PROCESSED MEMBER
5a FIRST MAIN SURFACE
5b SECOND MAIN SURFACE
51 SMALL PLATE PIECE
515 END SURFACE
53 OPENING MEMBER
531 OPENING PORTION
533 STRUCTURAL PORTION
535 END SURFACE
537 BASE PORTION
539 MOVABLE PORTION
551 GLASS MEMBER
553 DIFFERENT MATERIAL MEMBER
6 TOOL
61 POLISHING PORTION
8 FIXING MEMBER
81 FIXING PEDESTAL
83 PASTE
9 ELECTRONIC MEMBER

What is claimed is:

1. A manufacturing method of a processed member comprising:
removing a first uplift portion from a plate member comprising the first uplift portion and a support portion connecting to the first uplift portion, wherein
the plate member includes a first main surface and a second main surface,
the first uplift portion is a projection portion in the first main surface and a portion in the second main surface, corresponding to the projection portion is a recess portion, and
the first uplift portion has a line shape in a top view.

2. The manufacturing method according to claim 1, wherein the first uplift portion is removed by grinding with a grinding stone.

3. The manufacturing method according to claim 1, wherein the first uplift portion is removed by polishing with abrasive grains.

4. The manufacturing method according to claim 1, wherein the first uplift portion is removed in a state where the second main surface of the plate member is fixed by a fixing member.

5. The manufacturing method according to claim 1, wherein the first uplift portion is endless in a top view.

6. The manufacturing method according to claim 1, wherein the first uplift portion includes a base portion and a protrusion portion.

7. The manufacturing method according to claim 1, wherein the first uplift portion is formed by a vacuum shaping method.

8. The manufacturing method according to claim 1, wherein the first uplift portion is formed by a press shaping method.

9. The manufacturing method according to claim 1, wherein the first uplift portion has a thickness of 5 mm or smaller.

10. The manufacturing method according to claim 1, wherein the first uplift portion has a thickness thinner than a thickness of the support portion.

11. The manufacturing method according to claim 1, wherein the first uplift portion has a thickness 90% or smaller with respect to a thickness of the support portion.

12. The manufacturing method according to claim 1, wherein the processed member includes two or more first uplift portions.

13. The manufacturing method according to claim 12, wherein a minimum distance between the two or more first uplift portions is 10 mm or smaller.

14. The manufacturing method according to claim 1, wherein the plate member is made of glass.

15. A plate member comprising: a first uplift portion, a support portion connecting to the first uplift portion, and an alignment mark, wherein
the plate member comprises a first main surface and a second main surface,
the first uplift portion is a projection portion in the first main surface and a portion in the second main surface, corresponding to the projection portion is a recess portion, and
the first uplift portion has a line shape in a top view.

16. The plate member according to claim 15, wherein the first uplift portion comprises a base portion and a protrusion portion.

17. The plate member according to claim 15, wherein the first uplift portion has a thickness of 5 mm or smaller.

18. The plate member according to claim 15, wherein the first uplift portion has a thickness thinner than a thickness of the support portion.

19. The plate member according to claim 15, wherein the first uplift portion has a thickness 90% or smaller of a thickness of the support portion.

20. The plate member according to claim 15, comprising two or more first uplift portions.

21. The plate member according to claim 20, wherein a minimum distance between the two or more first uplift portions is 10 mm or smaller.

22. The plate member according to claim 15, wherein the first uplift portion is endless in a top view.

23. The plate member according to claim 15, made of glass.

24. An opening member comprising a plate having a first main surface and a second main surface, wherein
the plate comprises an opening portion and a structural portion forming and supporting the opening portion, and
a top-view projected shape formed by an end surface of the opening portion, on the first main surface side, is different from the top-view projected shape on the second main surface.

25. The opening member according to claim 24, wherein a top-view end surface shape formed by an end surface of the opening portion on the first main surface side has a relation of being included in a top-view end surface shape formed by an end surface of the opening portion on the second main surface side.

26. The opening member according to claim 24, wherein the plate further comprises a base portion protruding toward the plate on the first main surface side of the plate, and the opening portion is provided on the base portion.

27. The opening member according to claim 24, wherein the structural portion has a thickness of 5 mm or smaller.

28. The opening member according to claim 27, wherein the plate comprises two or more opening portions and a minimum distance between the two or more opening portions is 10 mm or smaller.

29. The opening member according to claim 24, wherein the plate is made of glass.

30. The opening member according to claim 29, wherein at least one of the two main surfaces of the plate includes a compressive stress layer.
